(19) United States
(12) Patent Application Publication
(10) Pub. No.: US 2010/0217613 A1
(43) Pub. Date: Aug. 26, 2010

(54) METHODS AND APPARATUS FOR PROVIDING CHARITABLE CONTENT AND RELATED FUNCTIONS

(76) Inventor: Brian Kelly, Charlotte, NC (US)

Correspondence Address: GAZDZINSKI & ASSOCIATES, PC, 16644 WEST BERNARDO DRIVE, SUITE 201, SAN DIEGO, CA, 92127, US

(21) Appl. No.: 12/393,981

(22) Filed: Feb. 26, 2009

(51) Int. Cl. G06Q 99/00; H04N 7/173

(52) U.S. Cl. 705/1.1; 725/91; 725/34; 725/24; 725/61

(57) ABSTRACT

Methods and apparatus for providing charitable content or features to a plurality of users in a content-based network. In one embodiment, charitable content is stored and retrieved by a server upon user request in an on-demand fashion. The user is also provided with the ability to make monetary charitable donations via the user's account. Apparatus and methods for delivery of content and/or data to e.g., cellular telephones, e-mail accounts, physical mail addresses, PSTN or VoIP telephones, etc. are also disclosed In one variant, data regarding a user's activities with respect to various types of content (including charitable content) is colleted and used to make charitable content recommendations and/or to provide charitable organizations lists of users who have donated and/or requested information regarding charitable organizations in the past. Business methods implementing various aspects of the above-described aspects are also provided.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The invention relates generally to the fields of content (e.g., video, audio and data) transmission and delivery. In one exemplary aspect, the invention relates to the use of an on-demand (e.g., VOD) infrastructure in a content-based network such as a cable television network to provide a viewer with the ability to interact with one or more charitable organizations or features.

2. Description of Related Technology

Charitable Organizations

There are at present thousands of charitable organizations in the world. Many charities are established with the goal of assisting one or more persons in need; however, charities are also established for other purposes. For example, some charities aim to assist or preserve plants, animals, or ecosystems facing crises; still others focus on issues affecting the entire world. A charitable organization's goal may be long or short term in nature, and may be created in response to a certain event (e.g., Hurricane Katrina disaster relief, Southeast Asian tsunami, etc.).

Charities and other non-profit organizations do not operate as traditional businesses, thus generally earn no “profit” (other than what is needed to keep the organization operating). Although a charitable organization may sell a product or a chance at winning a product or money (such as for a fund raiser, etc.), in general, a charitable organization's income is derived primarily from donations. Thus, charitable organizations, in general, cannot function without the generosity of donors. In an effort to receive contributions, charitable organizations must therefore actively seek donations.

Each charitable organization may seek different types of donations from donors. The most common type of donation sought is a monetary donation. Monetary donations are used by charitable organizations to inter alia finance the organization's daily operations, such as by paying for advertising, office space, and supplies. Also, monetary donations can be used to directly and indirectly advance the organization's goals, such as by e.g., purchasing emergency food supplies for disaster-stricken areas. Monetary donations, once collected, may be given by the charitable organization directly to the people or organizations that the organization serves, or the donations may be used to buy tangible items which are then given to the people the organization serves.

Donations to charitable organizations may include donations of life-giving substances. For example, it is common for donors to donate their blood or blood plasma to organizations such as a blood bank, hospital, or other organization. Donations of blood are often used in medical procedures whether routine or emergency. Similarly, donors donate one or more organs (e.g., kidneys, heart, lungs, liver, and pancreas), as well as other tissues etc. Donors may also donate a variety of other tangible goods to charitable organizations such as, food, water, blankets, clothes and automobiles (the latter which may be resold or auctioned off to provide money for the charity).

Charitable organizations are often in need of actual manpower to accomplish a variety of the organization's goals. Thus, donors are often sought to volunteer time to assist in the day-to-day operations of the organization, as well as for specific tasks such as assisting with building a house, mentoring a child, or distributing donated items.

There are several means by which charitable organizations may request the aforementioned types of charitable contributions from potential donors. For example, a charitable organization may solicit donations on an in-person basis, such as outside retail stores, etc. A charitable organization may also solicit donations via the postal system, which takes less manpower than the face-to-face approach, yet which is also more impersonal. Coupling the mail system with a computerized database of addresses tremendously increases the number of persons from which a charity can solicit.

The telephone allows charities to capitalize on the persuasiveness of the face-to-face method, while still being able to solicit the broad scope of potential donors that mailing is able to target. Though not a face-to-face conversation, a telephone call possesses a greater amount of personal appeal than a mere letter in the mail, the latter which may simply be thrown away by the recipient without reading.

The Internet has revolutionized almost every aspect of modern society, including the way in which charities solicit donations. The Internet allows almost instantaneous communication to anyone connected. Charities can reach out globally to perspective donors, such as via e-mail. Likewise, perspective donors may spontaneously reach out to various charities using a search engine to find charities (web sites) that most accurately align with the donor's opinions and sentiments.

Charities have also used television advertising, televised telethons, etc. as a means of soliciting donations. A variety of channels are available to a cable subscriber, including those dedicated to a multiplicity of genre (e.g. Sports, Movies, Comedy, Science Fiction, Horror, Children, Educational, News) and as well as a range of lifestyles (e.g. Fitness, Travel, Food, Alternative Lifestyle, Military, Religious). Thus, it is common for a charity (or any organization) to purchase advertisement on a particular channel and/or during a particular show in order to target a large number of people who have a substantially similar demographic classification or sentiment.

One particular method of seeking charitable donations via a television is by the aforementioned “telethon”. A typical telethon combines solicitations for donations and information about the charity (or charities) with entertaining acts and celebrity appearances. By this method, viewers are informed of the charities goals and prompted to donate, via telephone or Internet, while being entertained. Examples of a typical telethon include the Jerry Lewis Labor Day telethon for the Muscular Dystrophy Association, and the more contemporary American Idol™ “Idol Gives Back” episode. Television programs such as “Extreme Makeover—Home Edition” may also be considered charitable in nature, while not a telethon.

The aforementioned methods for soliciting charitable funds are largely inefficient or lacking for various reasons. For example, in order for a charity to increase donations, the charity must typically increase the number of persons who are solicited. However, increasing market penetration increases costs associated with the solicitation. Further, although a large number of people are contacted, there is no assurance that those contacted will have an interest in donating. It is a fact that a charity is more likely to receive a donation when the donor agrees with the charity's goals (e.g., a donor whose family member is paralyzed is more likely to make a donation to a charity that funds spinal cord research than to a charity that helps the homeless). Thus, it is advantageous to “target” those with prospectively the most interest in donating.

Another problem inherent with soliciting donations for charities is that donors may be reluctant to donate to a small or unknown charity for fear of being deceived. Donors do not have the time and resources to investigate the validity of a charitable organization and the identity of the solicitor. Unscrupulous people have profited from donations to counterfeit charitable organizations in the past, such as those posing to be representing police or other law enforcement. Similarly, it is possible that the solicitor is falsely claiming to be from a large, well-established charity (e.g. The Red Cross or Goodwill), but in truth is unaffiliated with any charity and is merely “spoofing” the donator.

Even after one has donated, there are no assurances that the donation in fact will get to the intended recipient(s).

Moreover, even when a charity finds someone sympathetic to his or her cause, the donor may be unwilling to give a donation until he/she is satisfied that the transaction will be secure. Donors may be reluctant to place cash or checks in the mail for fear that the letter will be unopened by an unintended party. Likewise, others will not give their credit card numbers via unsecured lines (such as telephone or Internet).

The previously described methods for collecting funds also do not account for the fact that a donor's willingness to donate will generally decrease relative the amount of time between having viewed or heard a solicitation, and actually taking steps to send a donation. So, if a charity is successful in obtaining donations, it is in the best interest of the charity to get the donation as quickly as possible.

It is also problematic that the prior methods of seeking donations are highly impersonal. Being able to capture the trust of the perspective donor is necessary. But, creating a personal relationship with the individual donor is a luxury that only the largest of charities can currently afford.

### Video on Demand

The provision of “on-demand” (OD) services, such as e.g., video on-demand (VOD), is well known in the prior art. In a typical configuration, the VOD service makes available to its users a selection of multiple video programs that they can choose from, and watch over a network connection with minimum setup delay. At a high level, a VOD system consists of one or more VOD servers that pass and/or store the relevant content, one or more network connections that are used for program selection and program delivery, and customer premises equipment (CPE) to receive, decode and present the video on a display unit. The content is typically distributed to the CPE over a Hybrid Fiber Coaxial (HFC) cable network or satellite (wireless) network.

Depending on the type of content made available and rate structure for viewing, a particular VOD service could be called “subscription video on demand (SVOD)” that gives customers on demand access to the content for a flat monthly fee, “free video on demand (FVOD)” that gives customers free on demand access to some content, “movies on demand” where VOD content consists of movies only, and so forth. Many of these services, although referred to by names different than VOD, still share many of the same basic attributes including storage, network and decoder technologies.

Just as different varieties of VOD service offerings have evolved over time, several different network architectures have also evolved for deploying these services. These architectures range from fully centralized (e.g., VOD servers at a central location) to fully distributed (e.g., multiple copies of content distributed on VOD servers very close to customer premises or network “edge”), as well as various other network architectures there between. Since most cable television networks today consist of optical fiber towards the “core” of the network which are connected to coaxial cable networks towards the edge, VOD transmission network architectures may also consist of a mixture of optical fiber and coaxial cable portions.

The CPE for VOD often consists of a digital cable set-top box (DSTB) that provides the functions of receiving cable signals by tuning to the appropriate RF channel (e.g., QAM-modulated carrier), processing the received signal and outputting VOD signals for viewing on a display unit. Such a digital set-top box also typically hosts a VOD application that enables user interaction for navigation and selection of VOD menu.

A key difference between VOD and typical broadcast television is that the VOD customer, unlike someone who is just watching broadcast television, determines what is being displayed on the television and when it is being displayed. VOD content is also delivered via sessions that are user-specific, and these sessions can be controlled by the user via inter alia so-called “tick mode” functions (e.g., rewind, FF, pause, etc.).

Given the foregoing, it is clear that what is needed are improved apparatus and methods for providing information regarding various charities to a television viewer. Such apparatus and methods would utilize extant network architecture (e.g., the VOD system) to provide charitable content upon request; and employ existing network architecture to allow a viewer to donate contemporaneously using e.g., their remote control or CPE. Such architecture would allow for a simple and nearly instantaneous transaction which would be of benefit to both the donator and the charity (and also to some degree the MSO or network operator).

Such improved systems and methods would further incorporate MSO-initiated research or guarantees to ensure the various charities presented are legitimate and that a donation will be used for the purpose or purposes that the donor desires.

Providing a means for secure donations would also be advantageous. Security in donations may include, inter alia, maintaining the anonymity of a donor (e.g. keeping the donor's identity, donor's address, and other account-related information secret) and guaranteeing donations will reach the intended recipients.

An exemplary system would also employ various mechanisms for providing information regarding charitable organizations to persons most interested in that charity's goals, thereby reducing costs associated with inefficient mass solicitations.

Ideally, an exemplary system would also be interactive so as to provide a donor with the ability to find out more about the charity's cause and upcoming events, and/or communicate with other donors.

### SUMMARY OF THE INVENTION

The present invention satisfies the foregoing needs by providing, inter alia, improved apparatus and methods for the provision of content regarding a charitable organization or function, and various mechanisms for permitting a viewer to make charitable contributions or provide other inputs over a content-based network.

In a first aspect of the invention an apparatus adapted for charity-related content delivery is disclosed. In one embodiment, the apparatus is adapted for charitable content delivery in a content-based (e.g., cable or satellite) network, the apparatus comprising: a processor; a network interface a storage device in data communication with the processor; and a software process operative to run on the processor. The software process is adapted to: generate information regarding available charitable content elements; receive a user selection of one or more of said available charitable content elements; deliver said selected one or more charitable content elements to said user; and receive a donation from said user.

In one variant, the apparatus comprises a cable television network headend or switching hub server. The apparatus may comprise e.g., a VOD or other such server.

In another variant, the delivery comprises storing a plurality of available charitable content on the storage device. In still another variant, the delivery comprises sending the selected charitable content to a designated network address or location. In yet another variant, the delivery comprises displaying the selected charitable content on a display device in data communication with the apparatus.

In still yet another variant, the receipt of a donation comprises receiving a message comprising information relating a donation and the user or donor.

In a second aspect of the invention, a method of providing charitable content to a user of a network is disclosed. In one embodiment, the network comprises a content-based network (e.g., cable or satellite network) having a plurality of users associated therewith, and said method comprises: indicating available charitable content to said user; receiving one or more selections of said available charitable content from said user; and providing said selected charitable content to said user over said network.

In one variant, said act of indicating available charitable content comprises providing said user a list of said available charitable content.

In another variant, said act of receiving one or more selections comprises: said user selecting one or more of said available content using a remote control device; and transmitting said selection(s) to a network server using a session control protocol.

In still another variant, said act of receiving a selection comprises: accessing metadata associated with at least one of said available charitable content; evaluating said metadata with respect to a user profile; and selecting content based at least in part on said evaluating.

In a further variant, said method further comprises collecting data regarding at least one of a user's (i) viewing patterns, (ii) charitable content requests, or (iii) charitable donations; and wherein said user profile comprises metadata associated with said viewing patterns.

In another variant, the method further comprises selecting an option to donate to said charitable organization associated with said provided charitable content. The donation comprises e.g., a monetary donation, and said method further comprises: delivering said monetary donation to said charitable organization; and billing said user.

In another variant, said donation comprises a non-monetary donation, and said method further comprises sending information to said charitable organization regarding said donation and said donor.

In a third aspect of the invention a method of providing exchange of information is disclosed. In one embodiment, said method comprises: providing said user with access to a plurality of charitable organizations; selecting an option to communicate with at least one of said organizations; generating a message based on said selection; and delivering said message to said selected at least one charitable organization.

In one variant, said act of selecting an option to communicate with said charitable organization comprises said user selecting an option to receive additional information from said organization via their network CPE.

In another variant, the message comprises contact information regarding said user comprising at least one of a name, physical address, email address, or telephone number of said user. The act of generating said message comprises said user entering said information, or alternatively occurs automatically by utilization of stored contact information regarding said user. The stored information comprises e.g., information contained in a billing or subscriber database maintained by an operator of said network.

In a further variant, said act of selecting an option to communicate with said charitable organization comprises said user selecting an option to make a charitable donation to at least one of said organizations. The message comprises for example information necessary to bill a user an amount at least equal to said user's donation.

In another variant, the act of selecting an option to communicate with said charitable organization comprises confirming a scheduled appointment.

In still another variant, said providing said user with access to a plurality of charitable organizations comprises creating a virtual channel for viewing by said user, said virtual channel integrating charitable content from at least two different sources. Integrating content from at least two different sources comprises for example presenting content that is delivered via two different delivery modes.

In another variant, said message comprises scheduling information comprising at least date, time, and location.

In yet a further variant said message comprises information relating to at least one of: (i) user's desire to volunteer time, and (ii) to a donation pick-up time.

In a fourth aspect of the invention a computer readable apparatus is disclosed. In one embodiment the computer readable apparatus comprises media adapted to contain a computer program having a plurality of instructions, the plurality of instructions which, when executed: generate a list of available charitable content for display; display the list of available charitable content to a user; enable selection of one or more of the available charitable content; and cause delivery of the selected one or more charitable content to at least the user.

In one variant, the apparatus is disposed on a client premises device in communication with a cable network, and the act of generating a list of available charitable content comprises obtaining metadata from a network server.

In another variant, the program is further adapted to enable selection of one or more subsequent actions with respect to the selected charitable content. The subsequent actions may comprise at least one of: donating to the one or more charitable organization; receiving additional information regarding the one or more charitable organizations; or scheduling events with the one or more charitable organizations.

In still another variant, the program is further adapted to: collect data regarding user preferences, the data comprising data regarding a user's prior charitable content selections, prior charitable donations, or general viewing patterns; evaluate metadata regarding the available charitable content; generate a list of available charitable content matching the user preferences.

In a fifth aspect of the invention a system for providing opportunities for viewing content is disclosed. In one embodiment a system for providing opportunities for viewing charitable content and making charitable donations in a content based network, the system comprises: a processing apparatus, the processing apparatus being adapted to generate a list of available charitable content; a first user interface enabling a viewer to select one or more of the available charitable content; apparatus adapted to allocate a carrier to deliver the selected one or more charitable content; a receiving apparatus, the receiving apparatus adapted to receive the charitable content; and a second user interface enabling a viewer to designate a donation to the charitable organization.

In one variant, the donation to the charitable organization comprises a monetary donation and wherein the system further comprises apparatus adapted to: deliver the monetary donation to a charitable organization associated with the charitable content; and bill the viewer a monetary amount equal to or less than that amount designated for donation.

In another variant, the donation to the charitable organization comprises a donation of non-monetary assets and wherein the system further comprises apparatus adapted to send a message comprising information regarding the donation and the viewer to the charitable organization.

In still another variant, the processing apparatus comprises a cable television network headend or switching hub server. In yet another variant, the processing apparatus is located substantially on a consumer premises device, and the receiving apparatus comprises a hard disk drive of the consumer premises device.

In yet another variant, the mechanism adapted to allocate a carrier to deliver the selected one or more charitable content comprises a VOD server in data communication with one or more remote charitable content stores and adapted to access charitable content stored thereon.

In still yet another variant, the system further comprises a data collection apparatus adapted to collect data regarding individual ones of the plurality of CPE, the data comprising information relating to: (i) the charitable organizations about which charitable content is requested from individual ones of the plurality of CPE, or (ii) an amount of charitable donations made from individual ones of the plurality of CPE.

In a sixth aspect of the invention, CPE adapted to provide charitable content and allow user interface with one or more charitable functions is disclosed. In one embodiment, the CPE comprises a settop box or converged premises device (CD), and the functions include at least one of: (i) making donations; (ii) requesting additional information; and (iii) requesting a listing of similar or related charities.

In a seventh aspect of the invention, a software architecture useful in providing charity-related content delivery and functions is disclosed. In one embodiment, the architecture comprises a distributed application (DA) having a server portion and a client portion. In one variant, the server portion is disposed to run on the aforementioned server apparatus, and the client portion on a user's CPE The client portion provides inter alia necessary user interfaces for various charity-related functions, and optionally collects data (such as user donation, activity or tuning data) to be sent to the server portion.

In an eighth aspect of the invention, methods of doing business relating to charities, charitable-related content and associated features are disclosed.

Other features and advantages of the present invention will be immediately recognized by persons of ordinary skill in the art with reference to the attached drawings and detailed description of exemplary embodiments as given below.

### BRIEF DESCRIPTION OF THE DRAWINGS

FIG. 1 is a functional block diagram illustrating an exemplary HFC cable network configuration useful with the present invention.

FIG. 1a is a functional block diagram illustrating one exemplary HFC cable network headend configuration useful with the present invention.

FIG. 1b is a functional block diagram illustrating one exemplary local service node configuration useful with the present invention.

FIG. 1c is a functional block diagram illustrating one exemplary broadcast switched architecture (BSA) network useful with the present invention.

FIG. 2 is a functional block diagram illustrating an exemplary network configuration for providing opportunities for charitable donations under an “on-demand” delivery paradigm.

FIG. 2a is a functional block diagram illustrating an alternate network configuration for providing opportunities for charitable donations.

FIG. 3 is a functional block diagram illustrating one embodiment of a charitable content server and database for use in the present invention.

FIG. 3a is a block diagram illustrating a first embodiment of a software architecture useful in providing charitable content and related functions according to the invention.

FIG. 3b is a block diagram illustrating a second embodiment of a software architecture useful in providing charitable content and related functions according to the invention.

FIG. 3c is a block diagram illustrating a third embodiment of a software architecture useful in providing charitable content and related functions according to the invention.

FIG. 4 is a logical flow diagram illustrating one embodiment of the generalized methodology of providing charitable content to a viewer.

FIG. 5 is a logical flow diagram illustrating one exemplary embodiment of the method of making monetary charitable donations according to the present invention.

FIG. 6 is functional block diagram illustrating one embodiment of a content-based network configuration for providing charitable content to mobile client devices on-demand.

FIG. 7a is a logical flow diagram illustrating an exemplary embodiment of the generalized method of distribution of charitable content to a mobile device (e.g., cellular telephone).

FIG. 7b is a logical flow diagram illustrating an exemplary embodiment of the generalized method of distribution of charitable content to an e-mail account.

FIG. 7c is a logical flow diagram illustrating an exemplary embodiment of the generalized method of distribution of charitable content to a home.

FIG. 8 is a logical flow diagram illustrating an exemplary embodiment of the generalized method by which data regarding a user's preferences is collected.

### DETAILED DESCRIPTION OF THE INVENTION

Reference is now made to the drawings, wherein like numerals refer to like parts throughout.

As used herein, the term “advertisement” and similar forms refers without limitation to any audio, visual, or promotion, message, or communication, whether for profit or otherwise, that is perceptible by a human. Examples of advertisements include without limitation so-called “bumper” advertisements (advertisements inserted before or after a client requested program), “pause” advertisements (presented when a client sends a pause control command to a video server or the like), or additional and replacement advertisements.

As used herein, the term “application” refers generally to a unit of executable software that implements a certain functionality or theme. The themes of applications vary broadly across any number of disciplines and functions (such as on demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the terms “charity”, “charitable organization”, and similar forms include, but are not limited to, international charities (e.g. Red Cross, Amnesty International, United Nations Children's Fund), religious organizations, branches of the military (e.g. Army, Navy, Marine Corps, Air Force, Coast Guard, National Guard) and Veterans organizations such as DAV, U.S. federal government organizations (e.g. Smithsonian Institute, Peace Corps, Health Resources and Services Administration), U.S. state government organizations (e.g. Universities, California Department of Forestry and Fire Protection), local government organizations (e.g. Police, Sheriff, Fire Department), colleges, sporting organizations, musical organizations, theatrical organizations, political organizations and political candidates.

As used herein, the terms “client device” and “end user device” include, but are not limited to, set-top boxes (e.g., DSTBs), personal computers (PCs), and minicomputers, whether desktop, laptop, or otherwise, and mobile devices such as handheld computers, PDAs, personal media devices (PMDs), cellular telephones, and smartphones.

As used herein, the term “codec” refers to an video, audio, or other data coding and/or decoding algorithm, process or apparatus including, without limitation, those of the MPEG (e.g., MPEG-1, MPEG-2, MPEG-4, etc.), Real (RealVideo, etc.), AC-3 (audio), DiVX, XViD/ViDX, Windows Media Video (e.g., WMV 7, 8, or 9), ATI Video codec, or VC-1 (SMPTE standard 421M) families.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (e.g., BREW), and the like.

As used herein, the term “consideration” refers without limitation to a payment, incentive, option, forbearance of a debt, credit, or any other thing or act which conveys monetary or any other type of value between two or more parties, such as for example cash or credit/debit payments, credits to account, erasure of debt, exchanges, barters, options or rights of first refusal.

The terms “Consumer Premises Equipment (CPE)” and “host device” refer to any type of electronic equipment located within a consumer's or user's premises and connected to a network. The term “host device” refers generally to a terminal device that has access to digital television content via a satellite, cable, or terrestrial network. The host device functionality may be integrated into a digital television (DTV) set. The term “consumer premises equipment” (CPE) includes such electronic equipment such as set-top boxes, televisions, Digital Video Recorders (DVR), gateway storage devices (Furnace), and ITV Personal Computers.

As used herein, the term “display” means any type of device adapted to display information, including without limitation: CRTs, LCDs, TFTs, plasma displays, LEDs, incandescent and fluorescent devices. Display devices may also include less dynamic devices such as, for example, printers, e-ink devices, and the like.

As used herein, the term “DOCSIS” refers to any of the existing or planned variants of the Data Over Cable Services Interface Specification, including for example DOCSIS versions 1.0, 1.1, 2.0 and 3.0. DOCSIS (version 1.0) is a standard and protocol for internet access using a “digital” cable network. DOCSIS 1.1 is interoperable with DOCSIS 1.0, and has data rate and latency guarantees (VoIP), as well as improved security compared to DOCSIS 1.0. DOCSIS 2.0 is interoperable with 1.0 and 1.1, yet provides a wider upstream band (6.4 MHz), as well as new modulation formats including TDMA and CDMA. It also provides symmetric services (30 Mbps upstream).

As used herein, the term “donation” or “gift” refers without limitation to any asset or consideration pledged to be given or actually given to a charity by one or more donors. Typical donations include, inter alia, tangible items such as money (cash, coin, check, credit card, etc.), food, water, shelter, blankets, blood, and organs, as well as intangible items such as volunteered time, etc.

As used herein, the term “donor” refers to an individual, entity or organization that makes a donation to a charity. In the scope of the present invention, the donor is not necessarily the owner of the asset given to the charity; for example, one can make a donation in another's name from their own or another's assets.

As used herein, the term “DVR” (digital video recorder) refers generally to any type of recording mechanism and/or software environment, located in the headend, the user premises or anywhere else, whereby content sent over a network can be recorded and selectively recalled. Such DVR may be dedicated in nature, or part of a non-dedicated or multi-function system.

As used herein, the term “headend” refers generally to a networked system controlled by an operator (e.g., an MSO or multiple systems operator) that distributes programming to MSO clientele using client devices. Such programming may include literally any information source/receiver including, inter alia, free-to-air TV channels, pay TV channels, interactive TV, and the Internet. DSTBs may literally take on any configuration, and can be retail devices meaning that consumers may or may not obtain their DSTBs from the MSO exclusively. Accordingly, it is anticipated that MSO networks may have client devices from multiple vendors, and these client devices will have widely varying hardware capabilities. Multiple regional headends may be in the same or different cities.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the terms “Internet” and “internet” are used interchangeably to refer to inter-networks including, without limitation, the Internet.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components.

As used herein, the terms “MSO” or “multiple systems operator” refer to a cable, fiber to the home (FTTH), fiber to the curb (FTTC), satellite, or terrestrial network provider having infrastructure required to deliver services including programming and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the terms “network agent” and “network entity” refers to any network entity (whether software, firmware, and/or hardware based) adapted to perform one or more specific purposes. For example, a network agent or entity may comprise a computer program running in server belonging to a network operator, which is in communication with one or more processes on a CPE or other device.

As used herein, the tern “network interface” or “interface” refers to any signal, data, or software interface with a component, network or process including, without limitation, those of the FireWire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), WiFi (802.11a,b,g,i,n), WiMAX (802.16), PAN (802.15), or IrDA families.

As used herein, the term “node” refers without limitation to any location, functional entity, or component within a network.

As used herein, the term “on-demand” or “OD” is meant to include any service that enables real, quasi-real time (e.g. “trick” mode delivery) or even non-real time delivery of content such as audio and/or video programs at any resolution, or data. Such content may be, for example, stored or temporarily cached on a server, or streamed directly from a source, and may be in response to a user-initiated event, service profile or configuration, headend event, or otherwise.

As used herein, the term “QAM” refers to modulation schemes used for sending signals over cable networks. Such modulation scheme might use any constellation level (e.g. QPSK, QAM-16, QAM-64, QAM-256 etc.) depending on details of a cable network. A QAM may also refer to a physical channel modulated according to the schemes.

As used herein, the term “server” refers to any computerized component, system or entity regardless of form which is adapted to provide data, files, applications, content, or other services to one or more other devices or entities on a computer network.

As used herein, the term “service”, “content”, “program” and “stream” are sometimes used synonymously to refer to a sequence of packetized data that is provided in what a subscriber may perceive as a service. A “service” (or “content”, or “stream”) in the former, specialized sense may correspond to different types of services in the latter, nontechnical sense. For example, a “service” in the specialized sense may correspond to, among others, video broadcast, audio-only broadcast, pay-per-view, or video on demand. The perceivable content provided on such a “service” may be live, pre-recorded, delimited in time, undelimited in time, or of other descriptions. In some cases, a “service” in the specialized sense may correspond to what a subscriber would perceive as a “channel” in traditional broadcast television.

As used herein, the term “service group” refers to either a group of service users (e.g. subscribers) or the resources shared by them in the form of entire cable RF signal, only the RF channels used to receive the service or otherwise treated as a single logical unit by the network for resource assignment.

As used herein, the term “storage device” refers to without limitation computer hard drives, DVR device, memory, RAID devices or arrays, optical media (e.g., CD-ROMs, Laserdises, Blu-Ray, etc.), or any other devices or media capable of storing content or other information.

As used herein, the terms “user channel” and “program channel” are all generally synonymous with the concept of a perceived stream or aggregation of information. For example, a program/user channel might comprise “Channel 3” which carries the content of a given network (e.g., NBC). This is to be distinguished from a physical channel, which is used to physically carry and distribute the content, which may for example comprise one or more QAMs within a given portion of the RF spectrum of a cable system.

As used herein, the term “user interface” refers to, without limitation, any visual, graphical, tactile, audible, sensory, or other means of providing information to and/or receiving information from a user or other entity.

As used herein, the term “WiFi” refers to, without limitation, any of the variants of IEEE-Std. 802.11 or related standards including 802.11 a/b/g/n.

As used herein, the term “wireless” means any wireless signal, data, communication, or other interface including without limitation WiFi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

In one salient aspect, the present invention discloses methods and apparatus for providing charitable content and/or data to a plurality of users in a content-based network. This content may be delivered under different types of paradigms, such as via the network's extant on-demand infrastructure. In one embodiment, the network comprises a cable television network, and the charitable content and/or data is stored at a headend database and retrieved by an on-demand server upon request by a CPE. Alternatively, the charitable content and/or data may be held at a more centralized or third party database from which on-demand servers of different headends may pull charitable content and/or data. The database(s) may also be disposed at and operated by a third-party, such as a charitable organization or charity aggregator.

In another embodiment, the charitable content is delivered as part of a “virtual” channel which is specifically tailored to one or more particular network subscribers.

In another aspect of the invention, apparatus and methods are described for enabling monetary charitable donations via the content-based (e.g., cable or satellite) network and a user's account associated therewith. The present invention provides the user with the ability to select, via a remote control, an option to have money donated to a charitable organization, and a monthly or other bill generated to include the donation. This bill my be integrated with the user's existing monthly bill for other services as well.

In yet another aspect of the invention, apparatus and methods are described for alternative delivery of content and/or data including, e.g., delivery to cellular telephones or 3G smartphones, e-mail accounts, physical mail addresses, home telephones (PSTN or VoIP “land lines”), etc.

In another aspect, data is collected regarding a user's activities with respect to content and/or data. The collected data is then used to recommend charitable content and/or data to users, and/or may be used by the MSO to provide charitable organizations with a list of users who have donated to and/or requested information regarding a specific charitable organization in the past. The presented methods and apparatus advantageously provide this information while maintaining user anonymity if desired.

In another variant, the MSO or other network operator acts as a clearing house or aggregator of charitable information and interface, assuring or even guaranteeing its customers of the authenticity and delivery of donations for charities to which it provides access.

Business methods implementing the above-described aspects are also provided.

### Detailed Description of Exemplary Embodiments

Exemplary embodiments of the apparatus and methods of the present invention are now described in detail While these exemplary embodiments are described in the context of the aforementioned hybrid fiber coax (HFC) cable architecture having an multi-system operator (MSO), digital networking capability, and plurality of client devices/CPE, the general principles and advantages of the invention may be extended to other types of networks and architectures where delivery of charity-related content and/or functions is required or desirable, whether broadband, narrowband, wired or wireless, content or data, or otherwise. Hence, the following description is merely exemplary in nature. For example, the invention may be practiced over a fiber-to-the-home (FTTH) or fiber-to-the-curb (FTTC) system, or over a satellite or millimeter wave-based network.

It will also be appreciated that while described generally in the context of a network providing service to a consumer (i.e., home) end user domain, the present invention may be readily adapted to other types of environments including, e.g., commercial/enterprise, and government/military applications. Myriad other applications are possible.

Moreover, while the primary embodiments described herein predominantly describe distribution of content (e.g., charity-related FVOD video), advertisements or promotions may likewise be distributed using the techniques of the present invention.

It is also noted that while aspects of the invention are described primarily in the context of 6 MHz RF channels within the HFC network, the present invention is applicable to any frequency/bandwidth, such as for example 8 MHz channels.

Further, while generally described in terms of content and/or data delivery over discrete QAMs or channels, relevant portions of the invention can be used in conjunction with multiplexing algorithm and wideband tuner apparatus such as that described in co-owned and co-pending U.S. patent application Ser. No. 11/013,671 filed Dec. 15, 2004, and entitled “Method and Apparatus for Wideband Distribution of Content” and which is incorporated herein by reference in its entirety.

Also, while certain aspects are described primarily in the context of the well-known Internet Protocol (described in, inter alia, RFC 791 and 2460), it will be appreciated that the present invention may utilize other types of protocols (and in fact bearer networks to include other internets and intranets) to implement the described functionality.

It will further be appreciated that while the exemplary embodiments presented herein are described in the context of services that include multicast transmission of data delivered over a network having virtual or logical channels, the present invention is applicable to other types of services that may include, for example, multicast and unicast data over physical or actual channels.

### Network Architecture

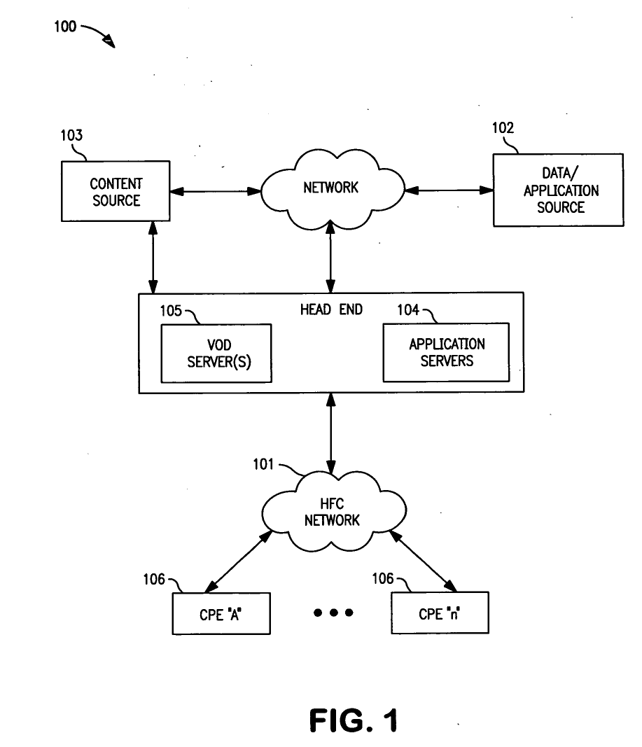

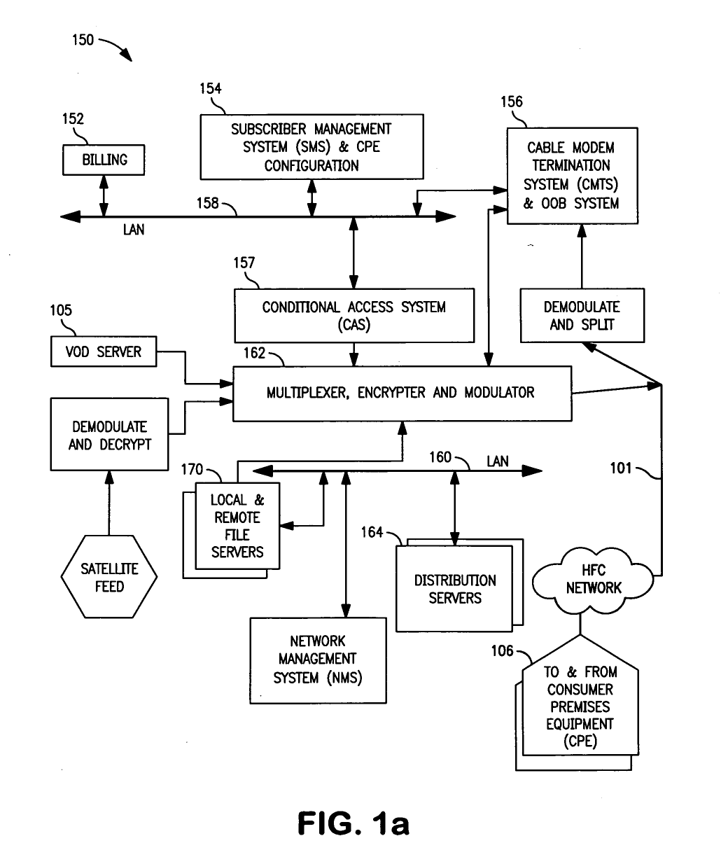

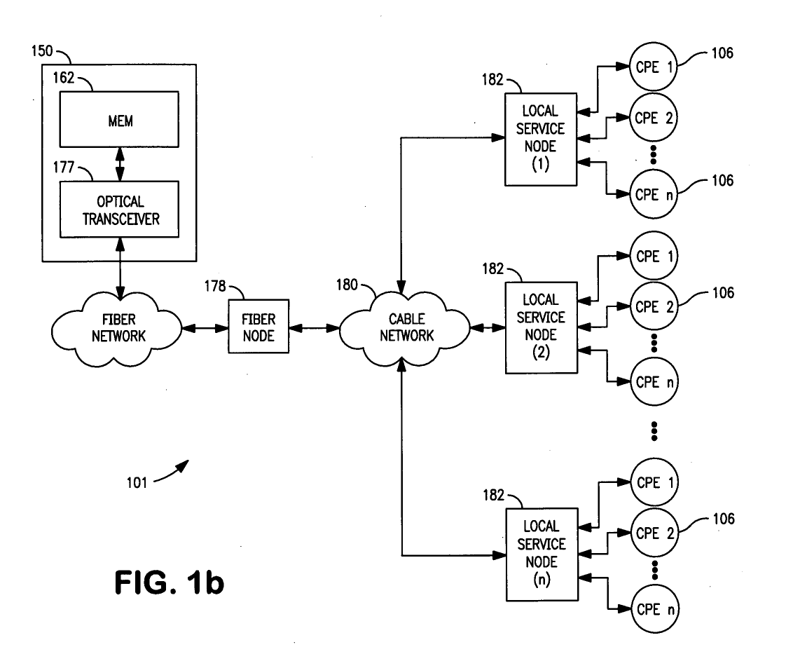

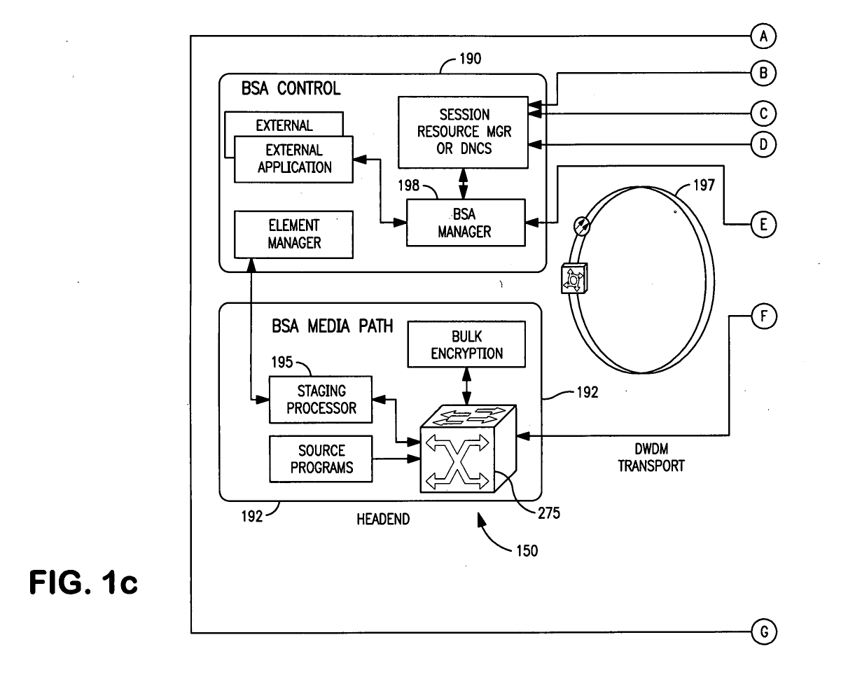

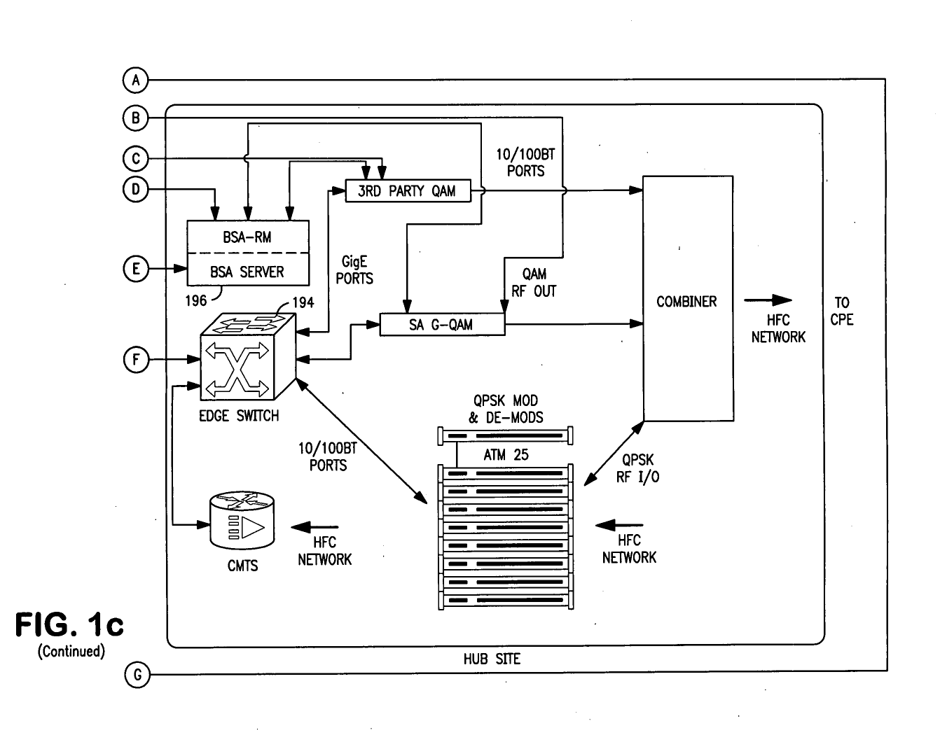

FIG. 1 illustrates a typical generalized content-based network configuration with which the charitable content delivery apparatus and methods of the present invention may be used. The various components of the network 100 include (i) one or more data and application origination points 102; (ii) one or more content sources 103, (iii) one or more application distribution servers 104; (iv) one or more VOD servers 105, and (v) consumer premises equipment (CPE) 106. The distribution server(s) 104, VOD servers 105 and CPE(s) 106 are connected via a bearer (e.g., HFC) network 101. A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the invention. For example, the headend architecture of FIG. 1a (described in greater detail below) may be used.

Furthermore, as discussed in greater detail subsequently herein, the generalized network of FIG. 1 also includes one or more interfaces to other (e.g., external) networks that can be used for the “personalized” delivery of content and/or data.

The data/application origination point 102 comprises any medium that allows data and/or applications (such as a VOD-based application, interactive charity application, gaming application, or “Watch TV” application) to be transferred to a distribution server 104. This can include for example a third party data source, application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 comprises a computer system where on-demand content and/or data can be received from one or more of the aforementioned data sources 102 and enter the network system. These servers may generate the content locally, or alternatively act as a gateway or intermediary from a distant source.

The CPE 106 includes any equipment in the “customers' premises” (or other locations, whether local or remote to the servers 104, 105) that can be accessed by a distribution server 104 or VOD server 105. Exemplary CPE 106 may also comprise “converged” CPE (i.e., CD), such as that described in co-owned and co-pending U.S. patent application Ser. No. 11/378,129 filed Mar. 16, 2006 entitled “METHODS AND APPARATUS FOR CENTRALIZED CONTENT AND DATA DELIVERY”, incorporated herein by reference in its entirety, which discloses a remotely manageable premises device that, inter alia, acts as a centralized client networking platform providing gateway services such as network management as well as traditional content and high-speed data delivery functions. The device also acts as the shared internet (e.g., Internet) connection for all devices in the premises via a cable modem or other such interface; metadata associated with personal and DVR content such as video, music and photos throughout the premises via may also be utilized as will be described below. Telephony services utilizing e.g., embedded multimedia terminal adapter (eMTA) and/or WiFi architectures may also be provided via the device 106; these services can make use of the network operator's indigenous VoIP or comparable telephony capability if desired, thereby providing an even more unified service environment and a mechanism for the various devices to communicate and interact with one another.

Referring now to FIG. 1a, one exemplary embodiment of headend architecture useful with the present invention is described. As shown in FIG. 1a, the headend architecture 150 comprises typical headend components and services including billing module 152, subscriber management system (SMS) and CPE configuration management module 154, cable-modem termination system (CMTS) and OOB system 156, as well as LAN(s) 158, 160 placing the various components in data communication with one another. It will be appreciated that while a bar or bus LAN topology is illustrated, any number of other arrangements as previously referenced (e.g., ring, star, etc.) may be used consistent with the invention. It will also be appreciated that the headend configuration depicted in FIG. 1a is high-level, conceptual architecture and that each MSO may have multiple headends deployed using custom architectures.

The architecture 150 of FIG. 1a further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). As previously described, information is carried across multiple channels. Thus, the headend must be adapted to acquire the information for the carried channels from various sources. Typically, the channels being delivered from the headend 150 to the CPE 106 (“downstream”) are multiplexed together in the headend and sent to neighborhood hubs (FIG. 1b) via a variety of interposed network components.

It will also be recognized, however, that the multiplexing operation(s) need not necessarily occur at the headend 150 (e.g., in the aforementioned MEM 162). For example, in one variant, at least a portion of the multiplexing is conducted at a BSA switching node or hub (see discussion of FIG. 1c provided subsequently herein). As yet another alternative, a multi-location or multi-stage approach can be used, such as that described in U.S. patent application Ser. No. 11/048,334, entitled “APPARATUS AND METHODS FOR MULTI-STAGE MULTIPLEXING IN A NETWORK” incorporated herein by reference in its entirety, which discloses inter alia improved multiplexing apparatus and methods that allow such systems to dynamically compensate for content (e.g., advertisements, promotions, or other programs) that is inserted at a downstream network node such as a local hub, as well as “feed-back” and “feed-forward” mechanisms for transferring information between multiplexing stages.

Content (e.g., audio, video, data, applications, etc.) is provided in each downstream (in-band) channel associated with the relevant service group. To communicate with the headend or intermediary node (e.g., hub server), the CPE 106 may use the out-of-band (OOB) or DOCSIS channels and associated protocols. The OCAP 1.0, 2.0, 3.0 (and subsequent) specification provides for exemplary networking protocols both downstream and upstream, although the invention is in no way limited to these approaches.

It will also be recognized that the multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

As shown in FIG. 1b, the network 101 of FIGS. 1 and 1a comprises a fiber/coax arrangement wherein the output of the MEM 162 of FIG. 1a is transferred to the optical domain (such as via an optical transceiver 177 at the headend or further downstream). The optical domain signals are then distributed to a fiber node 178, which further distributes the signals over a distribution network 180 to a plurality of local servicing nodes 182. This provides an effective 1 :N expansion of the network at the local service end.

### “Switched” Networks

FIG. 1c illustrates an exemplary “switched” network architecture also useful with the present invention. While a so-called “broadcast switched architecture” or BSA network is illustrated in one exemplary embodiment, it will be recognized that the present invention is in no way limited to this or any other architecture or delivery paradigm.

Switching architectures allow improved efficiency of bandwidth use for ordinary digital broadcast programs. Ideally, the subscriber will be unaware of any difference between programs delivered using a switched network and ordinary streaming broadcast delivery.

FIG. 1c shows the implementation details of one exemplary embodiment of this broadcast switched network architecture. Specifically, the headend 150 contains switched broadcast control and media path functions 190, 192; these element cooperating to control and feed, respectively, downstream or edge switching devices 194 at the hub site which are used to selectively switch broadcast streams to various service groups. A BSA server 196 is also typically disposed at the hub site, and implements functions related to switching and bandwidth conservation (in conjunction with a management entity 198 disposed at the headend). An optical transport ring 197 is utilized to distribute the dense wave-division multiplexed (DWDM) optical signals to each hub in an efficient fashion.

Co-owned and co-pending U.S. patent application Ser. No. 09/956,688 filed Sep. 20, 2001 and entitled “TECHNIQUE FOR EFFECTIVELY PROVIDING PROGRAM MATERIAL IN A CABLE TELEVISION SYSTEM”, incorporated herein by reference in its entirety, describes one exemplary broadcast switched digital architecture useful with the present invention, although it will be recognized by those of ordinary skill that other approaches and architectures may be substituted.

In addition to “broadcast” content (e.g., video programming), the systems of FIGS. 1a-1c can also deliver Internet data services using the Internet protocol (IP), although other protocols and transport mechanisms of the type well known in the digital communication art may be substituted. One exemplary delivery paradigm comprises delivering MPEG-based video content (e.g., “IPTV” or the like), with the video transported to user PCs (or IP-based STBs) over the aforementioned DOCSIS channels comprising MPEG (or other video codec such as H.264 or AVC) over IP over MPEG. That is, the higher layer MPEG- or other encoded content is encapsulated using an IP protocol, which then utilizes an MPEG packetization of the type well known in the art for delivery over the RF channels. In this fashion, a parallel delivery mode to the normal broadcast delivery exists; i.e., delivery of video content both over traditional downstream QAMs to the tuner of the user's STB or other receiver device for viewing on the television, and also as packetized IP data over the DOCSIS QAMs to the user's PC or other IP-enabled device via the user's cable or other modem.

Referring again to FIG. 1c, the IP packets associated with Internet services are received by edge switch 194, and forwarded to the cable modem termination system (CMTS) 199. The CMTS examines the packets, and forwards packets intended for the local network to the edge switch 194. Other packets are discarded or routed to another component.

The edge switch 194 forwards the packets receive from the CMTS 199 to the QAM modulator 189, which transmits the packets on one or more physical (QAM-modulated RF) channels to the CPEs (or CD). The IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve.

### Apparatus

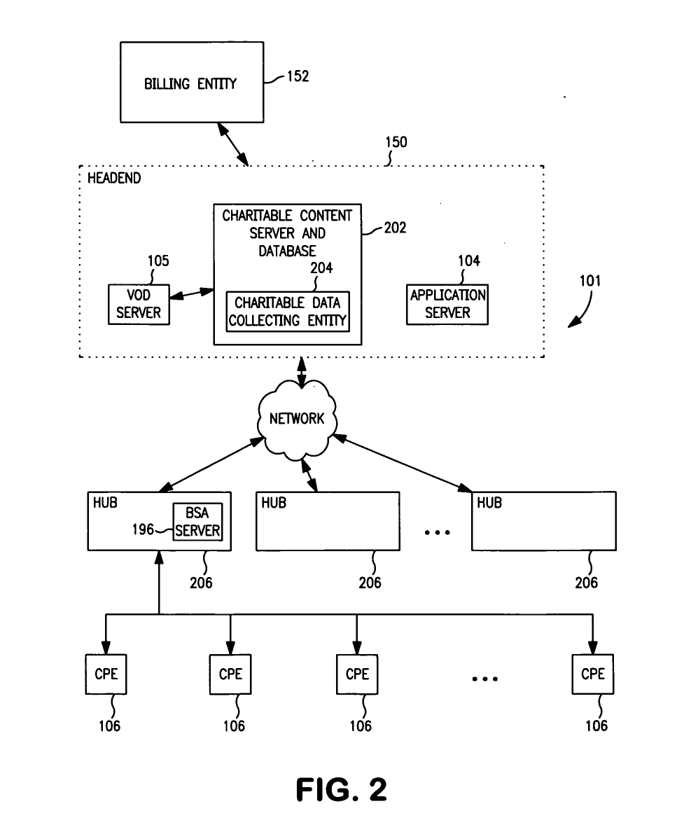

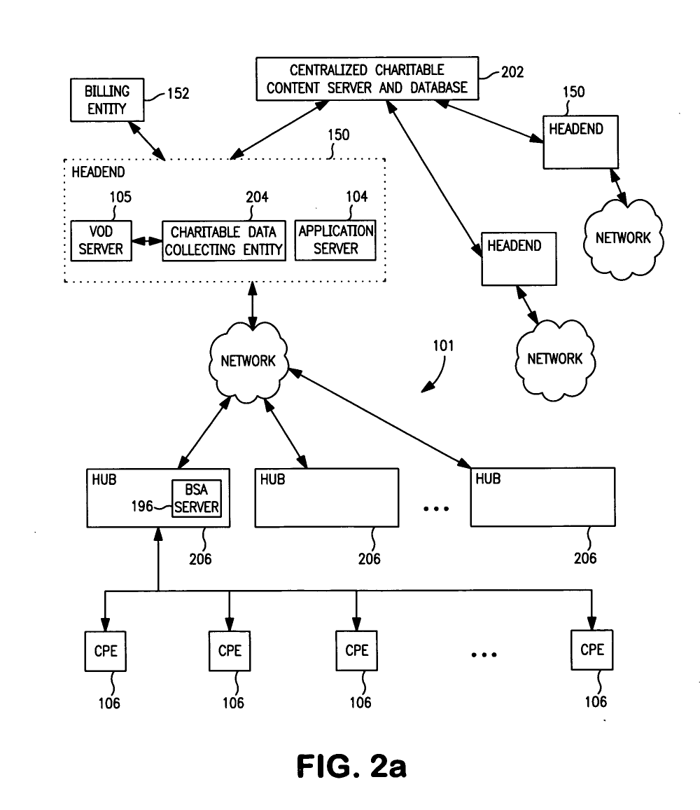

Referring now to FIG. 2, an exemplary apparatus for providing charity-related services and features according to the invention is described in detail.

It is noted that while the various exemplary embodiments described herein are given in terms of specific architecture and/or network topology (i.e., an “on-demand” delivery paradigm), other variations and combinations having alternative architectures, delivery paradigms and/or network topologies may be utilized depending on the attributes desired.

As illustrated in FIG. 2, the exemplary system comprises a plurality of CPE 106 associated with each of a plurality of hub entities. The CPE 106 has the capability to pull information (e.g., content and/or data) from at least one headend VOD server 105. In one embodiment, the CPE 106 select charitable content to view; the various methods by which charitable content is presented to the CPE 106 for selection will be discussed below. The charitable content comprises e.g., content developed by the charitable organization intended to provide a viewer with information regarding the goals of the charity and solicit donations of tangible items, money, volunteer time, etc. When the viewer selects to view charitable content, the VOD server 105 will receive the request, and subsequently obtain the content from a local headend charitable content server and database 202. The VOD server 105 will then send the content to the requesting CPE 106.

In an alternative embodiment (not shown), the charitable content server and database 202 will be present on (i.e., integrated with) one or more VOD servers 105; i.e., the VOD server 105 will be preloaded with charitable content, and will not be required to pull the content from an outside server or source.

Referring now to FIG. 2a, another embodiment of the apparatus for providing charitable content and/or data on-demand is given. According to the embodiment of FIG. 2a, the VOD server 105, rather than utilizing a headend charitable content server and database 202 (as shown in FIG. 2), pulls charitable content from a centralized charitable content server and database 202a. Charitable content would be held at the centralized entity 202a, thus supporting the utilization of the content by more than one headend 150, as shown. The multiple headend entities may also be associated with more than one MSO or service provider. For instance, the server and database 202a might comprise a third-party “charity aggregator” or clearing house.

In the systems of FIGS. 2 and 2a, while viewing the charitable content provided by the VOD server, the viewer is given various charitable donation options. These options include, inter alia, donating money, volunteering time, and donating other tangible items (e.g., food, clothing, etc.) to the charitable organization. The viewer is also given options for obtaining more information about the charitable organization selected, and/or particular needs or disasters served by the charity (e.g., “More info on Hurricane Katrina relief efforts”). If the viewer at the CPE 106 selects to donate money to a charity, the amount donated will be charged to the donor via existent methods utilizing a billing entity 152 to link the CPE 106 to the amount specified for donation. As described in greater detail below, the MSO, aggregator, etc. may also apply a “surcharge” or fee for their services if desired.

In one embodiment, the billing entity 152 acts as a depository for information about each user's account. Information stored may include, inter alita, a name, billing address, credit card number (with the appropriate data to enable a credit card transaction), Paypal or similar on-line payment account, and/or bank account information associated with a particular CPE 106 or household (to which several CPE 106 belong).

In an alternative embodiment, the abovementioned personal billing information is maintained at a headend entity (not shown). The billing entity 152, in this embodiment, is adapted to associate various charges (such as subscription charges, VOD event charges, pay-per-view charges, etc.) to an account number, which the headend entity is able to correlate to the aforementioned personal billing information. The account numbers maintained at the billing entity 152 will be associated with the one or more CPE 106 that are present in a household. Thus, when the billing entity 152 receives information regarding a purchased event from a VOD server 105, it will associate the CPE 106 the event occurred on with an account number, and then send this information on the headend entity for association to personal billing information.

In another variant, a hub entity (such as the BSA server 196 of FIG. 1c, or VOD SRM or other head-end entity, not shown) is adapted to compile information regarding a particular CPE 106. In one embodiment, the information collected may comprise information about prior donations attributed to the CPE 106. In an alternative embodiment, the information collected may comprise information relating to the viewing patterns at the CPE 106. The collecting entity may also be adapted to analyze at least portions of the collected data and/or send the data to a charitable data collecting entity 204 for storage, analysis and/or utilization (discussed below).

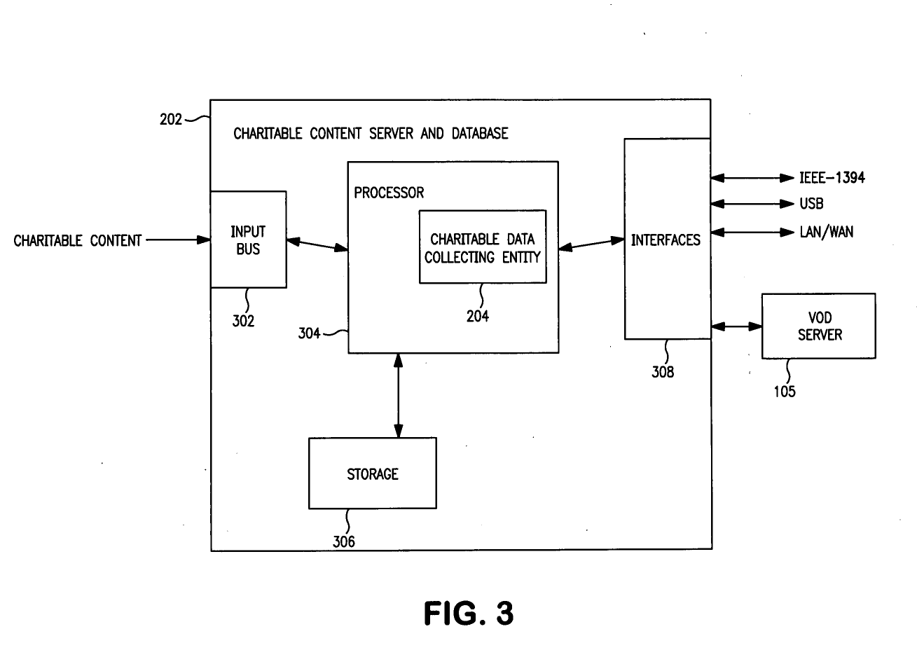

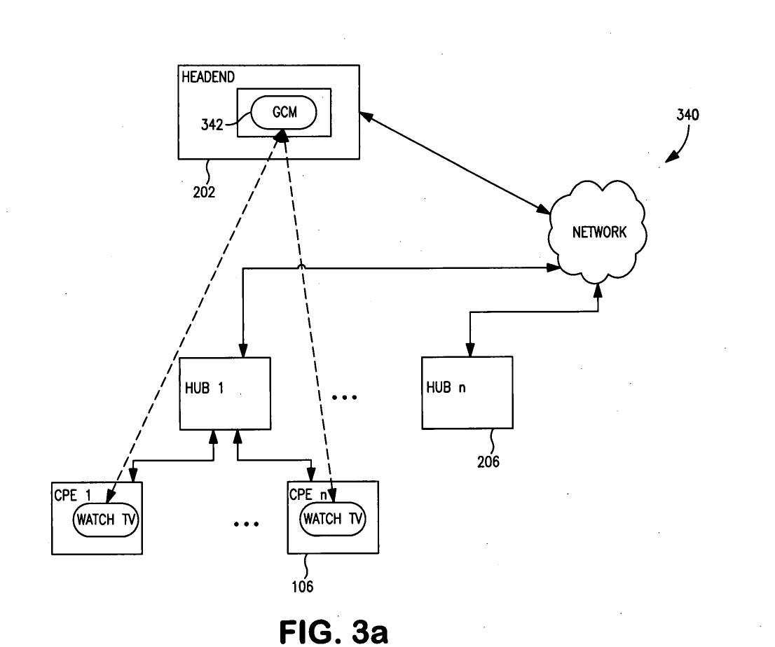

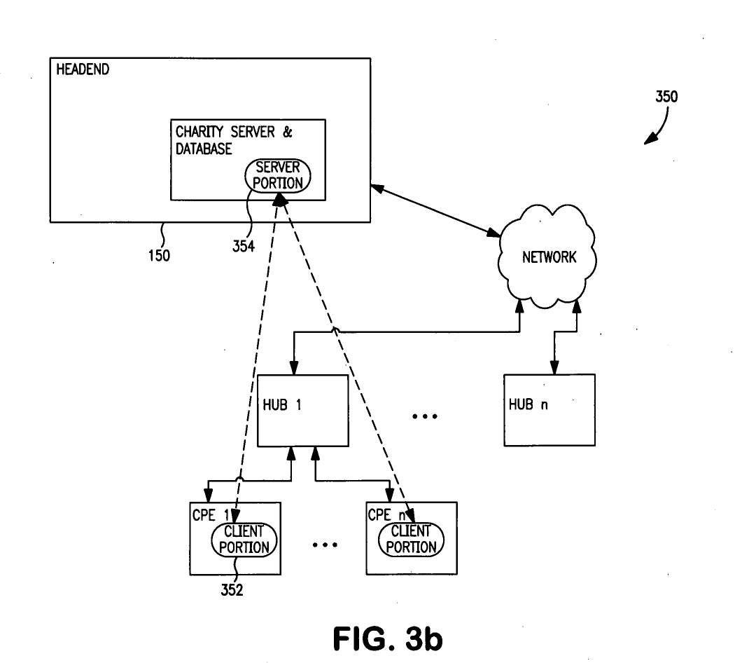

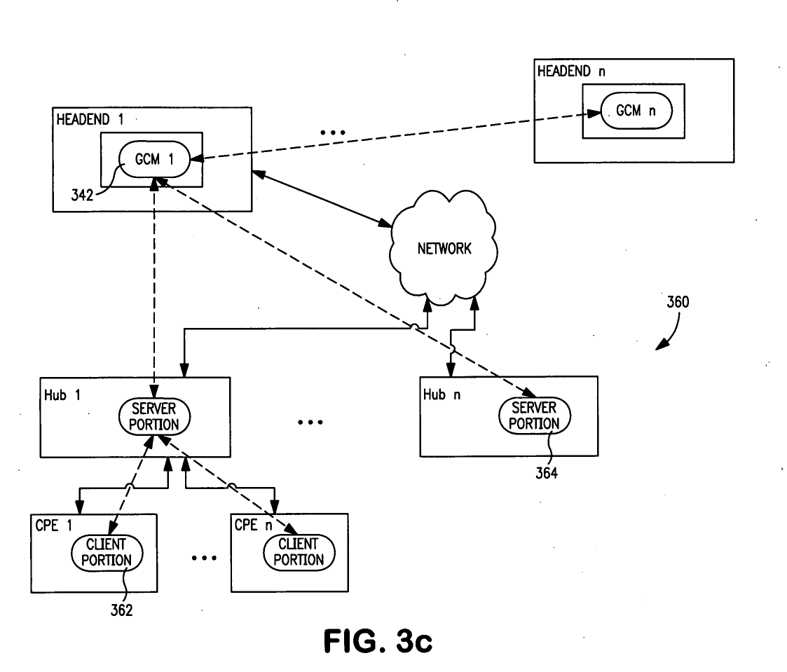

As yet another embodiment (see discussion of FIG. 3c below), one or more of the chanty server and database units 202 will be disposed closer to the edge of the delivery network, thereby allowing for edge-based service to the requesting CPE, which helps unload the core portion of the network and frees up the existing VOD servers for other tasks. The edge-based units 202 can also be configured to operate in a peer-to-peer fashion, such as where: (i) one unit 202 contains content not present on another, and a user being served by the other unit requests that content; or (ii) one unit 202 fails, and the subscribers served by that unit “fail over” to the remaining operating unit(s) 202.

### Charitable Content Server and Database

As noted above, the embodiments of FIGS. 2 and 2a utilize at least one charitable content server and database 202. An exemplary charitable content server and database 202 is illustrated in FIG. 3. As shown, the server and database 202 comprises inter alia an input bus 302, a storage device 306, a digital processor 304 and a plurality of interfaces 308 for connection to other devices in the network 101. The interfaces 306 also permit use of the server and database 202 with other network apparatus such as LANs, routers and other packet network devices, network management and provisioning systems, local PCs, etc. The charitable content database 202 is particularly adapted to interface with one or more VOD servers 105, so as to facilitate sending charitable content and/or data stored on the charitable content database 202 to one or more CPE 106.

The input bus 302 of the charitable content server and database 202 is the subsystem for the transfer of charitable content into the charitable content database 202 from other computers, etc. This content may be pre-formatted or encoded for use within the MSO network, or alternatively may be ingested in a “raw” format, and processed/encoded/transcoded on-the-fly when requested using e.g., an “intelligent” content caching controller. See, e.g., the exemplary methods and apparatus described in co-owned and co-pending U.S. patent application Ser. No. 11/904,375 filed Sep. 26, 2007 and entitled “METHODS AND APPARATUS FOR CONTENT CACHING IN A VIDEO NETWORK”, incorporated herein by reference in its entirety, which discloses methods and apparatus for the intelligent caching and de-caching of content within a content-based network using on-demand or other user-specified delivery. Specifically, the disclosure addresses issues relating to the trade-off between content storage space and transcoding/transrating/transcrypting efficiencies within the system that occur as a result of trying to support a broad range of end-user device profiles and capabilities. By evaluating the demand for certain content elements and formats within the network, and identifying “duplications” of requests (or alternatively, the “proximity” of one request to another in content/encoding/bitrate/encryption space), the caching controller of the present invention is able to dynamically balance caching of multiple versions of a content element (e.g., charity FVOD) and the need for “on-the-fly” transcoding/trasrating/transcryption and associated assets. In this fashion, greater efficiencies and economies of scale in operating the network can be realized while simultaneously supporting a wide range of devices.

Other approaches to obtaining, processing and storing (e.g., caching) content for delivery may be used consistent with the present invention as well.

The storage device 302 of the charitable content server and database 202 is adapted to store charitable a large quantity of content in one or more desired formats (e.g., multiple versions of the same FVOD video having different encoding/compression, bitrates, etc.). In an exemplary embodiment, content will not be placed on the charitable content database until the MSO has approved (or authenticated) the charity and/or the content. The content which is sent via the aforementioned VOD mechanisms typically comprises an audio/video stream (e.g., encoded in MPEG, Windows Media, Real, or other format). However, other content may be stored at the charitable content database 202, including, inter alia, text-based files or SMS messages to be sent to a user's e-mail, PDA or similar device and/or audio messages to be sent to a user's telephone. Mechanisms for sending the aforementioned content will be discussed in greater detail below.

As illustrated, the charitable content database 202 further comprises a digital processor 304 and server component, which, in the illustrated embodiment, houses a charitable data collecting entity 204. The charitable data collecting entity 204 of the illustrated embodiment comprises one or more computer programs/applications adapted to, among other things, collect data regarding requests for charitable content and monetary donations made to the various charities (see discussion of software architectures with respect to FIGS. 3a-3c provided subsequently herein). Data collected may include, but is not limited to: (i) the number of times a charity's content has been requested or viewed by subscribers of the network; (ii) the time and date of the requests; (iii) the amount of time the user spent viewing the charitable content; (iv) whether the viewer donated money to the charity; and (v) the amount of money donated. The collected data is stored in a given storage area of the storage device 306, or alternatively may be transmitted to another network or external entity (e.g., third-party charity data analysis consultant or algorithm) for processing and/or analysis.

Although illustrated in FIGS. 2, 2a, and 3 as an application running on the processor 304 of the charitable content database 202, it is appreciated that the charitable data collecting entity 204 may be run on a processor of another headend entity, a non-headend entity, and/or may comprise a separate (headend or non-headend) device. See e.g., FIGS. 3a-3c herein. Where the charitable data collecting entity 204 comprises a separate headend device, it is noted that the entity 204 may comprise the same or similar components and configuration as previously described headend entities (including the charitable content database 202).

Other components which may be utilized within both the charitable content server and database unit 202 include amplifiers, board level electronic components, as well as media processors and other specialized SoC or ASIC devices. Support for various processing layers and protocols (e.g., TCP/IP, 802.3, DHCP, SNMP, H.323/RTP/RTCP, VoIP, SIP, LSCP, XMPP, etc.) may also be provided as required. Where the content server is also acting in a local network capacity (e.g., as a VOD or application server), an appropriate application is also disposed to run on the server module 302 to provide a functional interface for e.g., VOD session requests received from the SRM or other entities. These additional components and functionalities are well known to those of ordinary skill in the cable and embedded system fields, and accordingly not described further herein.

It is also noted that, the charitable content server and database 202 may take any number of physical forms, comprising for example one of a plurality of discrete modules or cards within a larger network headend or edge device (e.g., VOD server 105) of the type well known in the art. The charitable content server and database 202 may also comprise firmware, either alone or in combination with other hardware/software components such as those previously described. The charitable content database 202 may even include its own RF front end (e.g., modulators, encryptors, etc.) or optical interface so as to interface directly with various portions of the HFC network 101 if desired. Numerous other configurations may be used. The charitable content server and database 202 may also be integrated with other types of components (such as satellite transceivers, encoders/decoders, etc.) and form factors if desired.

It is also appreciated that the techniques of the present invention may be practiced using any configuration or combination of hardware, firmware, or software, and may be disposed within one or any number of different physical or logical entities. For example, any required conditioning of the charity-related content before delivery (such as the inclusion of watermarking or other data, encryption, generation of encryption key pairs and/or challenges, and so forth) may take the form of one or more computer programs running on a single device disposed within the network, such as at a headend, node, or hub.

As yet another example, portions of the content distribution functionality may be rendered as a dedicated or application specific IC (ASIC) or DSP having code running thereon. For example, a security processor of the type well known in the art can be used to implement encryption algorithms on the delivered content, and/or to perform key pair generation and the like. These may also be used with respect to received transactions (e.g., donations) as discussed in greater detail subsequently herein. Myriad different configurations for practicing the invention will be recognized by those of ordinary skill in the network arts provided the present disclosure.

The charitable content server and database 202 (and collecting entity 204) can also be masked or controlled by a “business rules” engine” or other logical entity, wrapper or layer as described subsequently herein.

### Software Architecture

As described elsewhere herein, the present invention presents charitable content and/or related data to one or more CPE 106, converged devices, CMD 612, or computers 618 via the MSO network infrastructure (e.g., via an on-demand delivery paradigm), and enables users to make a monetary donations, obtain information, schedule volunteer and/or donation pick-up date, times, etc. Further, the present invention teaches a mechanism for collecting data regarding user activities with respect to content. The above functions are in one variant implemented by a VOD server 105, charitable content database and server 202, a charitable data collecting entity 204, a CPE 106, and/or other headend or hub entities, and are the result of one or more computer applications running on the digital processors thereof. However, as can be appreciated by those of ordinary skill, numerous different software architectures can be utilized consistent with the invention for implementing these functions.

For example, FIG. 3a illustrates a first exemplary software configuration 340, wherein the charity functions are all driven by a global charity manager (GCM) application 342 running on the charity server 202; e.g., including the data collecting entity 204 of FIG. 2. The GCM 342 in this embodiment coordinates and communicates with each of the different VOD servers 105 at a headend 150 (or multiple headends) to manage the charitable delivery and other functions across the network as a whole. No “client” software portions are utilized in this configuration 340 other that those extant to the system (e.g., existing VOD or navigator applications); hence, no data collection or other specialized functions are performed at the CPE 106 per se. Hence, this configuration 340 has the advantage of great simplicity and low communications bandwidth consumption, but it also is somewhat restricted in the charity-related feature set that can be offered.

FIG. 3b illustrates another exemplary software configuration 352, wherein a distributed application (DA) having a client portion(s) 352 and server portion(s) 354 is used. The client portion(s) 352 run on the CPE 106 and communicate with the server portion(s) 354 running on either the charity server and database 202 at the headend 150, or the VOD server(s) 105, in order to effect the various charity-related data collection, display, donation, inter-subscriber communication, and other features of the system. In one variant, the client portion is “thin” (i.e., not overhead/processing or resource intensive), and is integrated with extant applications running on the CPE such as a “Watch TV” or navigator application, or even the device middleware. Communication between the two portions may be accomplished using existing in-band or out-of-band (OOB) communication channels or other such channel available for inter-process communication, as is well known in the software arts. This embodiment is more capable (feature-wise) than the architecture of FIG. 3a, yet also has a greater complexity and communications bandwidth requirement (including at the “core” of the network).

FIG. 3c illustrates a third software configuration 360, wherein the GCM of FIG. 3a is used to coordinate the efforts of and support server portions 364 disposed on the various distribution nodes (e.g., servers disposed at the hubs 206 of FIG. 2), the latter which communicate with one or more respective client portions 362 disposed at the CPE. This architecture has the advantage of one centralized GCM (i.e., the ability to orchestrate charity-related functions across the entire network, or portions thereof as desired), while also providing for highly localized and more reliable functions at the hub level of the network (i.e., much of the data collection, processing, and communication functions are pushed out to the edge of the network, thereby not bogging down the core or the sole “controller” (i.e., GCM) as in the embodiment of FIG. 3a). Reliability is increased in that at least some functions can be provided to each CPE 106 by its local “hub” charity server in the event of GCM or other charity entity/server failure. However, this architecture 360 also has greater complexity in that each hub (or at least some of the hubs 206) must have its own charity server, which must also be independently maintained and updates, such as via communications with the GCM at the headend 150 (or other site).

### Presenting Charitable Content

As noted above, charitable content from a charitable content database 202 is provided to a viewer's CPE 106 or other network-accessible device. In order to provide this content, however, the user is in one embodiment given an opportunity to select it (as opposed to other embodiments wherein the MSO or a third party decides which charity-related content will be provided without direct user input).

In the on-demand model, the viewer selects at their CPE 106 which content to view, and issues a request from the CPE to the VOD server 105 (or directly to the charity server/database 202).

In a broadcast paradigm, the charitable content is broadcast over a BSA or other such broadcast infrastructure on one or more QAMs (which may also correspond to one or more program channels). The user may decide to switch to the relevant QAM (such as by selecting the appropriate program channel).

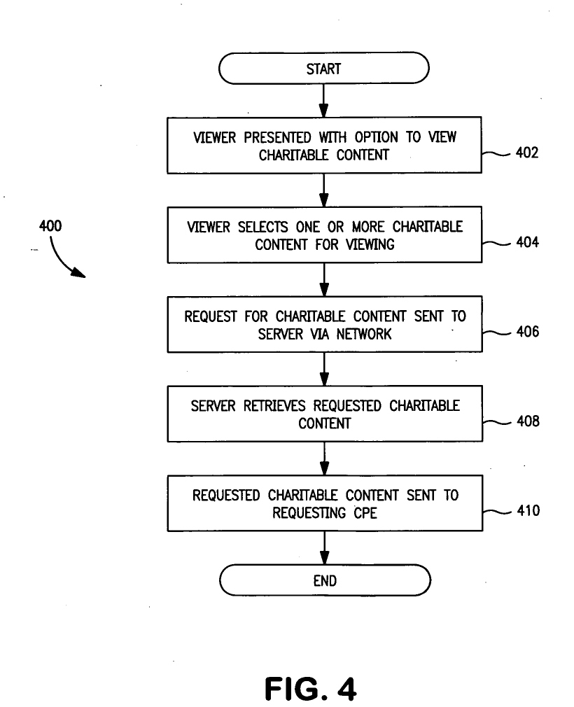

FIG. 4 gives an exemplary method 400 for providing charitable content to a viewer under an on-demand paradigm. It is appreciated that the provision of charitable content may be implemented by a VOD server 105, by the charitable content server and database 202, and/or by other headend or hub entities via one or more software applications adapted to run on the digital processors thereof.

Per step 402, a user is first presented with an option to view charitable content (e.g., a broadcast or FVOD video) from one or more charitable organizations. This presentation may take any number of different forms depending on the delivery paradigm, including for example: (i) via a traditional “EPG”-type display approach; (ii) via a VOD-like interface; (iii) via a dedicated “virtual” program channel; or (iv) via an IP-TV or Internet interface.

The user may also be presented with a hierarchical menu or display structure which allows them to select a charity or type of charity (e.g., Armed Forces-related charities) from a listing or other user interface mechanism, and then be presented specific content options relating thereto. Further, the list of charitable organizations (for which content and/or data is available) may be made searchable, such that the viewer may search the list for one or more specific organizations, category of organizations, and/or keywords.

In a first embodiment, step 402 comprises presenting the viewer with a traditional EPG-type interface, wherein the charitable content is displayed according to a linear time scale much as any other content (e.g., “Support our troops” charity drive) from 8:00 pm to 10:00 pm on a given day and program channel). This broadast-type delivery is akin to normal broadcast content delivery; however, the user interface presented with the content may allow the user to interact and for example donate using their remote and CPE 106 (such as via upstream OOB communication to the headend and billing module 152/charity server 202).

Alternatively, the user may be presented with a VOD-type interface showing just the charitable content or organizations available, or rather all types of content (including charitable and non-charitable content such as movies, etc.). The VOD interface may be accessed, for example, by the user tuning to a designated program channel (e.g., Channel 400), or a fixed-fiction key on their remote control.

As yet another alternative, the list of charitable content or organizations may be presented on a non-VOD interface (e.g., as a screen-corner icon or display element associated with a non-charitable content element such as a movie), but trigger the utilization of VOD mechanisms for presentation of the content and/or data and billing. For instance, a user may be watching a given broadcast or VOD content element, with a small Red Cross emblem being displayed in the lower left-hand or right-hand corner of the screen (display of this emblem or GUI element may also be coupled to temporally related events, such as when a disaster strikes). The emblem or icon is made interactive such that a user can use a cursor, designated button on their remote, etc. to activate it, such activation causing display of a short FVOD video or the like. In the case of VOD delivery, the primary content (e.g., movie) may also be automatically paused or stopped, such as by the CPE 106 issuing a LSCP command upstream to the parent VOD server 105, thereby preserving the user's place in their primary content. In the case of broadcast content or that with no associated “trick mode” capability, various mechanisms can be used for preventing the user from missing parts of the primary content due to viewing the secondary content, such as: (i) use of a PIP (picture-in-picture) display format; (ii) use of a divided screen; (iii) activation of a network PVR or similar “start over” feature that will start the content from the branch point where the secondary content was invoked; or (iv) local buffering or DVR recording of the missed content, and resuming playback after completion of the secondary content at the start of the buffer.

In another variant, a viewer is presented with an opportunity to select to view charitable content on-demand when an advertisement for a specific charity is broadcast. In other words, if during a broadcast program stream an advertisement for a charity airs, the viewer will be prompted to select an icon or remote button in order to view that charity's charitable content on demand, donate, and/or view more information.

It will also be recognized that the aforementioned emblematic/iconic approaches may also be contextually related to broadcast, VOD, or other “primary” content. See the discussion of context-based targeting provided subsequently herein.

In yet another embodiment, the viewer is presented at step 402 with a circulating loop of trailers from the various charities having content and/or data available. The viewer may interrupt a particular trailer and request to view the charitable content associated with the trailer (i.e., select charitable content during playing of the trailer, step 404). It is also appreciated that in this embodiment, searching may also be made available. The trailers presented may be presented on a VOD interface showing only charitable trailers, or alternatively, on an interface or program channel showing all types of content trailers, including non-charitable content (such as movies, etc.) trailers.

At step 404, the viewer selects one or more of the content elements presented via one or more of the foregoing mechanisms for viewing.

Per step 406, the request to view one or more charitable content is sent to the relevant serving entity/controller (e.g., VOD server, Charity server 202, or BSA server) via transmission through a local hub 206. Alternatively, the request may be sent to the VOD server without the utilization of a hub entity 206, i.e., directly from the requesting CPE to the VOD server such as via an alternate communication channel.

Then, per step 408, the serving entity (e.g., VOD server 105) establishes connection with entity on which the requested content is present (e.g., charitable content server and database 202 or other server) and retrieves the content. The requested content is then routed to the requesting CPE 106 via the network, at step 410.

In an alternative embodiment, charitable content may be presented to a user at a home network graphic user interface such as that described in co-owned U.S. Pat. No. 7,174,126 to McElhatten, et al. issued Feb. 6, 2007 and incorporated herein by reference in its entirety.

### Enabling Charitable Donations

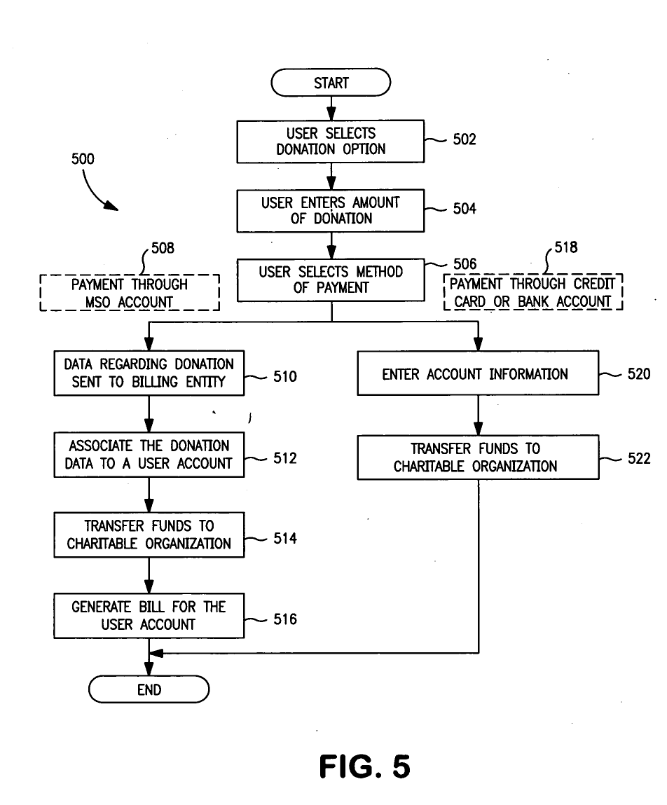

As noted above, when the viewer views charitable content, the viewer will be given various options including, inter alia, an option to donate money to the charitable organization. An exemplary method 500 by which monetary charitable donations are made according to the present invention is illustrated in FIG. 5. It is appreciated that enabling charitable donations may be a function of the VOD server 105, the charitable content database 202, the CPE 106, and/or by other headend or hub entities via one or more software applications adapted to run on the digital processors thereof. It may also be enabled by a third-party server; e.g., web server or the like.

As shown, per step 502, the viewer first selects an appropriate option indicating an intent to donate, i.e., a menu item, symbol, icon, graphic, or text description selectable by the user. At step 504, the user enters the amount of money to be donated. In one embodiment, the user may manually enter an amount via the remote control. Alternatively, preset amounts may be listed from which a user may select. These amounts may be one-time donations, or on a recurring basis (e.g., $X per month).

Next, the user will be prompted to select a method of payment (step 506). The various methods of payment from which the user may select include, inter alia, payment through the MSO (i.e., the subscriber's account), payment by a credit or debit card, or payment through a bank account (e.g., electronic transfer). Other payment services such as Paypal may also be utilized.

The user may select to pay through the account the user has established with the MSO for other (e.g. standard or subscription) services per step 508. Upon selecting to pay in this manner, data regarding the donation will be sent to the billing entity 152 at step 510. The data may include, inter alia, the identity of the charitable organization, the amount to be donated, as well as information regarding the user's CPE 106 (such as MAC address, one-way cryptographic hash (discussed in greater detail below), or other identifying information). Then, at step 512, the billing entity 152 (or other headend entity) will associate the data regarding the donation to a user account. This is accomplished by associating the information regarding the user's CPE 106 with one of the accounts maintained at the billing entity 152, and subsequently placing the information regarding the amount donated and charitable organization's identity into the account. This enables the billing entity 152 to generate a bill to the customer including the customer's regular service costs, any additional costs incurred, and the donation amount. This is also useful for updating the user's records for the donation; e.g., taking the deduction if applicable. The billing system can also be configured to send information regarding the donation transaction to a third party entity such as the IRS or the user's account, such as via electronic mail or letter.

At step 514, funds to cover the amount of the donation are transferred to the charitable organization. There are many mechanisms by which this may be accomplished, including, inter alia, the MSO making a payment to the charitable organizations based on all of its users' donations over some period (e.g., monthly); waiting to have received payment on a charitable donation from the user prior to making a payment to the charitable organization; or immediate payment of individual charitable donations.

Per step 516, at some regular interval, invoices (e.g., monthly bills) or other such documentation will generated by the billing entity 152 for each of the user accounts maintained thereon. As noted above, the bills will be associated to individual CPE 106 or households (having more than one CPE 106 associated therewith) and will include a charge in the amount of the charitable donation along with other charges incurred during the billing period.

As noted above, the user may alternatively select to pay through a personal credit/debit card or bank account (518). If the user selects this method, the user will be prompted, at step 520, to enter the credit/debit card or bank account information. At step 522 funds will be transferred to the charitable organization. In one variant, funds are transferred from the bank or the credit card company. According to this variant, the information entered at step 520 will be utilized by a headend entity to determine which company and notify the company of the intended transaction. The funds will then be transferred according to the bank or credit card company's mechanisms for such payments. One such mechanism is described in previously referenced U.S. Pat. No. 5,475,585 to Bush issued Dec. 12, 1995 entitled “Transactional Processing System”, incorporated herein by reference in its entirety.

Alternatively, funds may be transferred from to the charitable organization from the MSO, which will request reimbursement from the bank or the credit card company. Various business methods relating to the ability of a user to transfer fluids from a bank or credit card company to a charitable organization will be discussed in greater detail below.

It is also appreciated that where the user submits credit/debit card or bank account information, the MSO may implement one or more mechanisms for ensuring the secure transfer of this sensitive information including, inter alia, utilization of cryptographic hashing as discussed in co-owned and co-pending U.S. patent application Ser. No. 11/186,452 filed Jul. 20, 2005 and entitled “Method and Apparatus for Boundary-Based Network Operation”, which is incorporated herein by reference in its entirety.

The user's payment information may also be stored for quick recall, such as is commonly performed on many commercial Internet web sites. Storage of this information may be local (e.g., on the CPE 106 or other user premises device), or remote (such as on the MSO billing module 152 or the charity server and database 202).

Enabling Alternative Delivery of Content and/or Data

As noted above, when a user views charitable content, the user will be given various options including, inter alia, options for the receipt of data (via e-mail, telephone, postal mail, etc.), as well as options for connecting the user with others having similar interests and to the charitable organization's volunteer schedule. Providing these options is generally accomplished by directing charitable data and/or user contact information to Internet-capable client and/or charitable organization-operated devices, such as cellular telephones, PDAs, computers, etc.

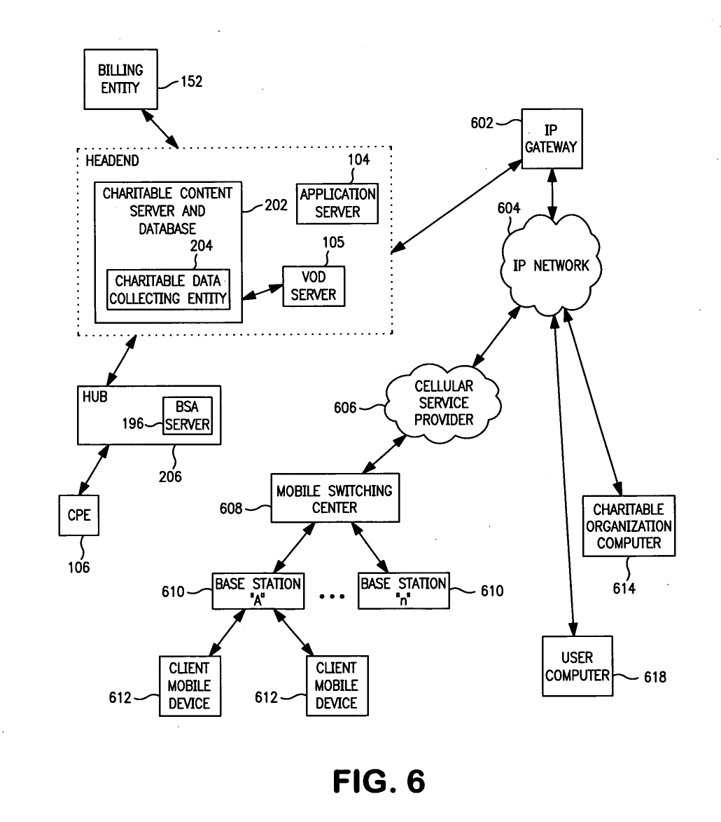

FIG. 6 illustrates an exemplary content-based network configuration within which charitable content and/or data of the present invention may be presented to mobile client devices in the context of an on-demand delivery paradigm. It will be appreciated that while on-demand delivery is described (see, e.g., co-owned and co-pending U.S. patent application Ser. No. 11/258,229 entitled “METHOD AND APPARATUS FOR ON-DEMAND CONTENT TRANSMISSION AND CONTROL OVER NETWORKS” filed Oct. 24, 2005 incorporated herein by reference in its entirety), the invention is in no way so limited; i.e., delivery may also be according to a broadcast or other delivery paradigm, such as via the exemplary Qualcomm MediaFLO content delivery system or similar type of architecture used in the context of a wireless mobile device.

The various components of the network of FIG. 6 include (i) one or more data and application origination points (not shown); (ii) one or more charitable content databases 202; (iii) one or more application distribution servers 104; (iv) one or more VOD servers 105; (v) network “gateway” or bridge 602, and (vi) client mobile devices (CMID) 612 and computers 614, 618 (“alternative devices”). The alternative devices 612, 614, 618 are connected to the application server(s) 104 and VOD servers 105 via a bearer (e.g., Internet Protocol and, in the case of CMDs 612, CSP) network 606, 604. A subscriber or user billing entity 152 is also provided. It is noted that FIG. 6 is representative of a simplified architecture; comparable architectures with multiple origination points, content and distribution servers, VOD servers, and/or CMD or computer devices (as well as different network topologies) may be utilized consistent with the invention.

The architecture illustrated in FIG. 6 may be utilized to provide content and/or data to various CMD 612 (the CMD 612 including, inter alia, cellular telephones, PDA, handheld internet capable devices, laptop computers, etc.), as well as to provide data to user computers 618 and charitable organization computers 614. In other words, FIG. 6 enables at least three mechanisms for the delivery of content and/or data. In the first, a user may request from his CMD 612 (cellular telephones, PDA, handheld Internet capable devices, laptop computers, etc.) charitable content on-demand. Second, a user may receive data regarding a charitable organization to a computer such as a network PC 618. Lastly, the architecture of FIG. 6 enables a charitable organization to receive data (e.g., contact information of interested or potentially interested donors) at a charitable organization operated computer 614.

The application origination point comprises any medium that allows an application (such VOD-based applications) to be transferred to an application distribution server 104. This can include for example an application vendor website, CD-ROM, external network interface, mass storage device (e.g., RAID system), etc. Such transference may be automatic, initiated upon the occurrence of one or more specified events (such as the receipt of a request packet or ACK), performed manually, or accomplished in any number of other modes readily recognized by those of ordinary skill.

The charitable content database 202, as discussed in the description of FIG. 2 above, may comprise any indigenous (i.e., MSO) or third party provider of charitable content, whether direct or indirect. This content may comprise an MPEG (e.g., MPEG-2) encoded stream, or otherwise. The content may also pass through one or more intermediary nodes or conditioning process before transmission over the network 101 via a VOD server 105 or other device, as is well understood in the art.

As noted above with respect to FIG. 2, the VOD server 105 is a computer system where on-demand content, as well as the data can be received from one or more data sources and enter the network system. These sources may generate the content/data locally, or alternatively act as a gateway or intermediary from a distant source. The VOD server 105 includes the Session Resource Manager (SRM) functionality, and asks the Digital Network Control System (DNCS) for resources. The DNCS responds with negative or positive response to the request, and the VOD server/SRM implements the appropriate resource allocation logic.

The gateway/bridge 602 shown in FIG. 6 may comprise, e.g., a DOCSIS 1.x or 2.x or EuroDOCSIS-compliant CMTS (cable modem termination system) or other such device. As is well known, the CMTS comprises devices typically located in the headend or hub site that allows high-speed IP network access via the indigenous HFC subscriber network and CPE/cable modem. The CMTS performs a lower layer translation of sorts between the HFC domain in which the cable modem operates (e.g., 16- or 256-QAM RF channels) and the packet switched network domain, and also facilitates coupling to an internet or IP backbone (such as via an ISP, or directly by the MSO). Typical network layer protocols used by the CMTS and packet switched domains include IP (Internet Protocol), for compatibility between the two domains. Hence, with a cable modern and CMTS, a cable subscriber can couple his/her TCP/IP-based computer to the cable modem, and both transmit and receive IP-based packets via the CMTS interface to an external IP backbone (and hence the Internet) or other data network. Quality of Service (QoS) with minimum and maximum rate service levels may also be provided, as well as inter alia link- or other-layer encryption and key management protocol, dynamic load balancing and frequency agility, support of multiple upstream and downstream channels, remote access server (RAS) capability, anti-spoofing functions, per subscriber filters, per cable modem DHCP assignments and per cable modem maximum number of subscribers.

Since content delivery is often in the form of a packetized protocol, the CMTS or other bridge device to the external IP network 604 can also take the packetized content directly from the server (after proper formatting, FEC, etc. as required) and vice versa.

Alternatively, the gateway/bridge 602 may comprise other devices adapted to provide internet/intranet/WAN/LAN/MAN/piconet connectivity outside the HFC domain, such as a protocol translator/packetizer coupled to a millimeter wave link for transmission to a distant location. Many possible configurations for the interface between the HFC and packet-switched networks are possible consistent with the invention, including those which provide AP/DS/ESS functionality in IEEE Std. 802.11 systems, H.323/VoIP gateways, and so forth. The present invention should in no way be considered limited to any particular style, configuration, location, or protocol of gateway or bridge.

It will be recognized that the multiple servers (VOD 105 or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups. An exemplary multi-server architecture useful with the present invention is described in co-pending and co-owned United States Patent Application Publication No. 20020059619 to Lebar published May 16, 2002 and entitled “Hybrid central/distributed VOD system with tiered content structure” which is incorporated herein by reference in its entirety. Specifically, a hybrid central/distributed and tiered video on demand (VOD) service network with tiered content structure is disclosed. In particular, the system uses media servers located in both the headend and hub stations. Set-top boxes (or CMD 612 and computers 614, 618) generally would be supplied VOD services from the high-demand content media servers located in the hub station nearest to the user.

It will also be recognized that a heterogeneous or mixed server approach can be utilized consistent with the invention. For example, one VOD server configuration or architecture may be used for servicing cable subscriber CPE-based session requests, while a different configuration or architecture may be used for servicing mobile client requests. Similarly, servers can either be single-purpose or dedicated (e.g., where a given server is dedicated only to servicing certain types of requests), or alternatively multi-purpose (e.g., where a given server is capable of servicing requests from multiple different sources).

The OD server can also be made to support multiple session protocols such as SIP, WASP/WSP, and SSP, thereby allowing it to be substantially agnostic to session requests received from heterogeneous types of alternative devices, e.g., CMD 612 and computers 614, 618 (assuming sufficient capabilities are negotiated and present for transfer of the desired content).

Alternatively, device services can be kept entirely separate of the extant cable plant, and separate optimization/multiplexing algorithms employed if necessary.

Many other permutations of the foregoing system components, architectures and communication methods may also be used consistent with the present invention, as will be recognized by those of ordinary skill in the field.

A CSP 606 (cellular service provider) provides mobile communication system services to cellular services subscribers. CSPs 606 include such companies as Verizon®, Cingular® and T Mobile® which carry voice and data over a network which can then deliver this voice and data to a client mobile device 612, and similarly receive data from mobile units and pass it to its destination (which may be another mobile unit, a POTS based user, a server, etc.).

A wireless service provider (WSP), sometimes also referred to as a WISP (wireless Internet service provider), generally provides wireless access to broadband or similar capabilities through a network of access points (such as the IEEE Std. 802.11 Access Points) located in areas such as libraries, Internet cafes, and other public gathering locations, may be utilized with the present invention as well. The WSP may utilize WiMAX and/or other technologies (such as MWBA or PAN) for implementation of its wireless air interfaces.

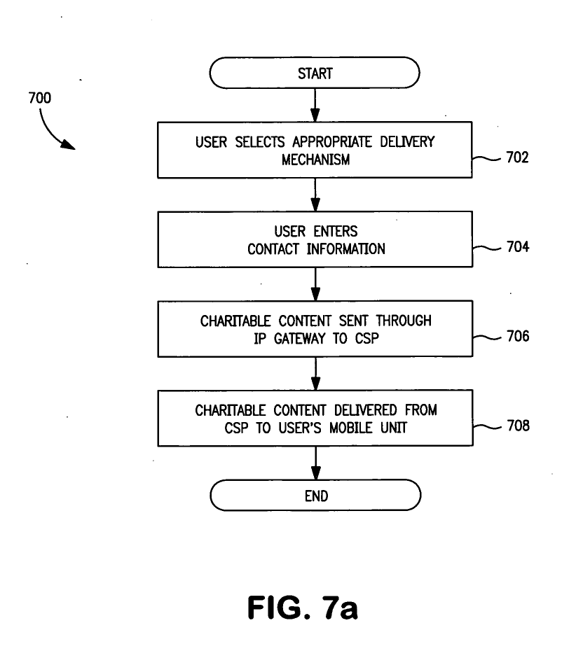

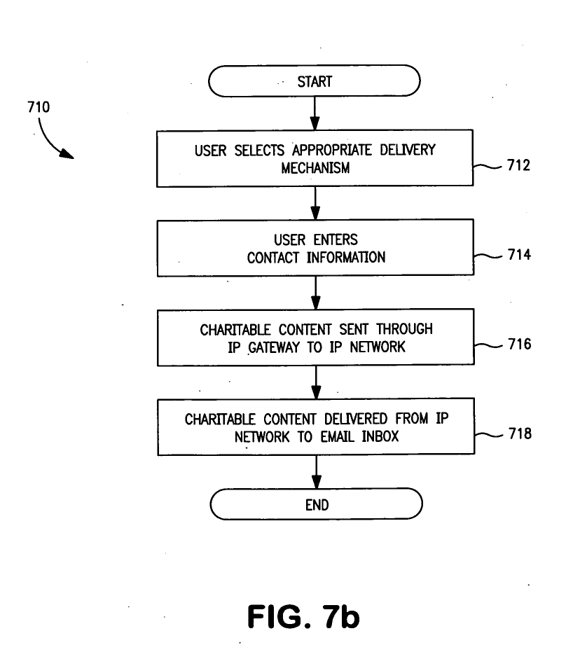

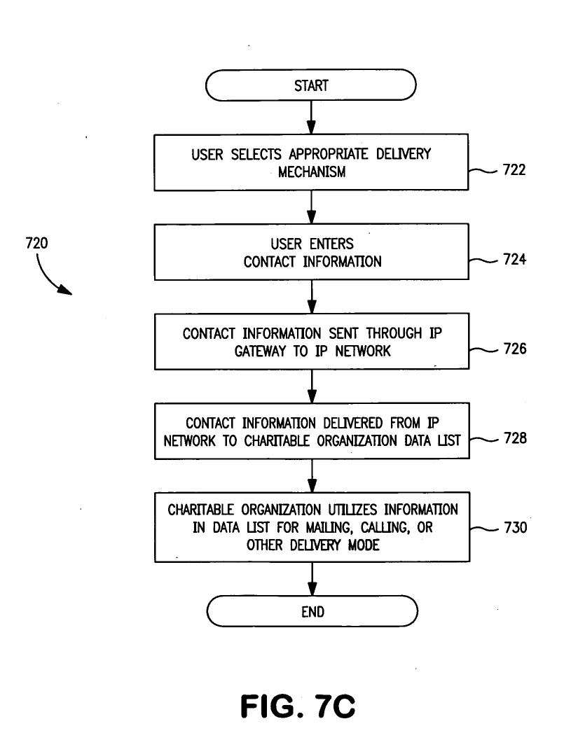

The above exemplary system configuration enables various methods for providing charitable content and/or data to alternative devices including, a user's cellular telephone (in the form of voice, video and/or text), a user's internet e-mail account (in the form of text, audio and/or video), and/or a user's physical mailing address (via transmission of contact information to a charitable organization operated computer 614). Exemplary embodiments of each of these methods are discussed below in FIGS. 7a, 7b, and 7c respectively. It is appreciated that providing alternative delivery of charitable content and/or data may be performed by the VOD server 105, the charitable content database 202, and/or by other headend or hub entities via one or more software applications adapted to run on the digital processors thereof.

Moreover, it will be recognized that the requesting entity need not be the delivery target entity. For instance, a user might use their CPE 106 to request delivery of information to their cellular telephone, or vice versa. Or, a PC might be used to access an MSO website to request information for delivery to the user's CPE. Myriad other combinations will be recognized by those of ordinary skill provided the present disclosure.

Referring now to FIG. 7a, a general method 700 for distribution of charitable content to a wireless CMD 612, such as a user's cellular telephone or smartphone, is illustrated. Mechanisms for delivery of content to a “landline” (POTS or PSTN) telephone will be discussed below.

As shown, at step 702, the user selects the appropriate delivery mechanism. At this step, the user selects an option to receive a text SMS, video, and/or voice message regarding the charitable organization, depending on the capabilities of their device. Depending on the origin of the request, these capabilities may also be auto-negotiated with the serving entity as part of step 702, such as via any number of extant service discovery protocols of the type well known in the wireless arts.

It is appreciated that in one embodiment, the charitable content may comprise audio/video content (the same or a shortened or differently encoded version of that presented to a user CPE 106). Exemplary methods for the delivery of audio/video content to a CMD 612 on demand are given in co-owned, co-pending U.S. patent application Ser. No. 11/258,229 previously incorporated by reference herein.

Alternatively, the charitable content may comprise a recorded audio message and/or an SMS or text message which are pre-loaded on to the charitable content server or database 202 (or alternatively on the VOD server 105) in anticipation of requests for information for delivery to a cellular telephone.

At step 704, the user is provided an opportunity to enter contact information (e.g., telephone number) for the device to which the user would like to have the message sent. This may also be selected using a GUI or similar user interface; e.g., by selecting an icon which corresponds to preloaded personal information including the user's cellular telephone number.

Once the user has entered the contact information, at step 706, charitable content will be delivered; for example, sent through the IP gateway 602 of FIG. 6 to the CSP 606. As discussed above, the charitable content is stored on the charitable content database 202, and will be pulled from the database 202 by the associated server (and/or VOD server 105). In one embodiment, the server will then forward the content to the IP gateway 602 which utilizes the IP network 604 for delivery of the content to the CSP 606. Other transports may be used as well.

At step 708, the CSP 606 transmits the content to a mobile switching center (MSC) 608; the MSC 608 routes the content to the appropriate base station 610 for final delivery to the CMD 612 associated with the contact information provided by the user (at step 704) via the wireless air interface of the cellular system.

Referring now to FIG. 7b, a general method 710 for distribution of charitable content to a user's e-mail account is illustrated. At step 712 of the method 710, the user selects the appropriate delivery mechanism (i.e., the user an option to receive an e-mail message regarding the charitable organization). This may also comprise a “default” user setting, so that the selection of step 712 need not be performed each time.

At step 714, the user is prompted to enter contact information (e.g., e-mail address) for the account to which the user would like to receive message. This information may also be pre-stored at the device with which the user interfaces, or on the charity server and database 202.

Once the user has provided the contact information, at step 716, charitable content will be sent, such as for example through the IP gateway 602 to the IP network 604. The charitable content sent according to this embodiment may comprise an audio/video content (the same or a shortened or differently encoded version of that presented to a user CPE 106), and/or a text message which are pre-loaded on to the charitable content database 202 (or VOD server 105) in anticipation of requests for information to an e-mail account. The server will then forward the content to the IP gateway 602 which utilizes the IP network 604 for delivery of the content to the user's e-mail account at step 718 (which is accessible at a user's computer 618).

Referring now to FIG. 7c, a general method 720 for distribution of charitable content to a user's home (via mail or telephone) is illustrated. As shown, at step 722, the user selects the appropriate delivery mechanism (i.e., the user selects the option to receive a letter or other physical, textual document or object (e.g., CD) and/or voice message to a “landline” regarding the charitable organization). Then, at step 724, the user is enters contact information (e.g., physical address or telephone number) for the device to which the user would like the letter or message sent.

At step 726, the entered contact information is sent through the IP gateway 602 to the IP network 604. In one embodiment, as the contact information is entered, it will be stored at a headend entity (e.g., the charitable content database 202); then, in a manner similar to that discussed above, the contact information will be pulled from the database 202 by the VOD server 105. The VOD server 105 will then forward the contact information to the IP gateway 602 which utilizes the IP network 604 (at step 728) for delivery of the contact information to a data list located on the charitable organization's computer 614. The information in the data list is then used, at step 730, to send physical mail or for solicitation by telephone.

In one variant of the aforementioned methods 700, 710, 720 for distribution of charitable content, the user need not manually enter contact information (such as email addresses, physical addresses, and/or telephone numbers) as given in steps 704, 714, and 724, respectively. Rather, previously entered contact information may be stored at a headend entity, a hub entity, or the user's CPE 106 and the user will be given an option to select at least one of the stored entries. In another variant, the stored contact information may be forwarded automatically upon selection of a method of delivery. In yet another variant, the user's contact information may be provided by the MSO and/or derived from account information associated with the CPE 106 from which the request for content is made.

### User Contact

In another aspect of the invention, the exemplary system configuration described above also enables providing options for: (i) connecting users with other users or organizations having similar interests, and (ii) connecting users to a charitable organization's volunteer schedule.

For example, in one embodiment, the user is given an option to communicate with other individuals having an interest in the charitable organization and/or its goals via an Internet user group or forum. To facilitate a meeting of various people via the Internet, an audio and/or video and/or text message (e.g., e-mail, “chat” message, “blog”, .wav file, etc.) is delivered or created upon user request, such as via any of the aforementioned methods 700, 710, 720 for delivering content or data given in FIGS. 7a-7c above. The message may contain a link to an on-line forum, instructions regarding how to access the forum, and may also contain information regarding events that will occur at the Internet forum (e.g., celebrities joining the forum, particular topics of interest, etc.).

In another exemplary embodiment, the user may be given an option to communicate with others via an in-person charity or support group. According to this embodiment, the user will be provided with information regarding dates, times, and locations via any of the aforementioned methods 700, 710, 720 for delivering content or data given in FIGS. 7a-7c above. A web log (“blog”) may also be used for this purpose. As noted, the message will contain information regarding the support group meeting details. Depending on the geographic scope of the charity, there may be a listing of multiple sites and multiple times for the support group meeting(s). The user will be given an opportunity to reply regarding whether the user will attend. Attendance replies may also be recorded and used to generate a display showing for example how many people have confirmed that they will be in attendance for each of the group meetings established.

In a similar manner, a user may via the aforementioned methods 700, 701, 720 receive information regarding a charitable organization's volunteer schedule. The user can utilize this information to schedule a day, time, and place for volunteering. The user will also be able to determine how many others will volunteer that day and be connected to them via the Internet or in-person as discussed above.

In a further embodiment, a direct “chat” or similar instant messaging feature is provided to place MSO subscribers in direct contact with other MSO subscribers who have expressed an interest in a charity, activity or event, and who have opted into being contacted. This chat functionality may be enabled on the subscriber's on-screen display, or on a client device such as a PC or mobile phone or PDA that is in communication with the MSO network. So, for example, one user may use their PC which is coupled to the network via a DOCSIS connection to send a chat invitation to another MSO subscriber, the list of subscribers being provided by the MSO according the aforementioned criteria. In this fashion, two or more MSO subscribers can communicate directly via the MSO infrastructure. In another variant, the user's CPE (e.g., set-top box, converged device (CD), or the like) may be used as the interface for communicating with other MSO subscribers, such as via an on-screen display window and the user's remote control unit, or via a wired or wireless device in communication with the converged device.

### Charitable Data Collection and Utilization

In one embodiment of the present invention, the systems for delivering charitable content and data to a user (exemplary embodiments of which are discussed with respect to FIGS. 2, 2a, and 6) utilize one or more mechanisms for collecting useful information regarding inter alia, (i) charitable contributions made by the user or other premises members, (ii) the user's interest in charitable content and information relating thereto, and (ii) instances of actual expression of user interest in receiving information regarding charitable organizations. As will be discussed in greater detail below, the collected information may be used to accomplish one or more business goals for the MSO and/or the relevant charities.

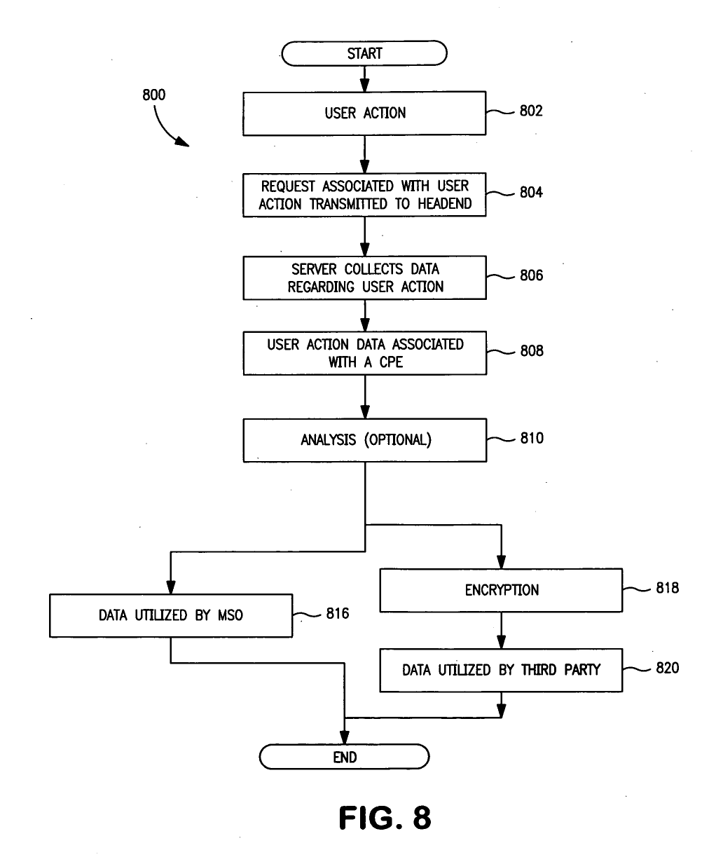

One embodiment of the generalized method 800 by which data is collected is given in FIG. 8. It is appreciated that the data collection function may be performed by the VOD server 105, the charitable content server and database 202, a charitable data collection entity 204, a BSA server 196, a CPE 106, and/or by other headend or hub entities via one or more software applications adapted to run on the digital processors thereof or even combinations of the foregoing. For instance, in one variant, a client application running on the CPE 106 may be used to monitor and gather information relating to activities on that CPE relating to charitable events, donations, requests for information, etc., and send this information to a network server (e.g., the charitable server 202) for storage and analysis. Any number of different architectures will be recognized by those of ordinary skill given the present disclosure.

At step 802, the user affirmatively acts with respect to content. The actions taken by a user may include, inter alia, ordinary tuning events (e.g., tuning to or tuning away from broadcast charitable content), affirmative requests to view charitable content (such as via a VOD session request), making monetary donations, requesting that information be sent to a CMD 612 or computer 618, etc. Content can be identified as “charitable” in nature by the MSO such as by encoding metadata within the content, or alternatively just based on point of origin or source. For instance, it may be known in advance that content broadcast on a given program channel at certain times is charitable, or that content pulled from a particular database 202 or served by a particular server is charitable in nature. Yet other approaches may be used as well.

The user actions occur at the user's CPE 106 and transmitted, at step 804, in one form as requests to the headend entity responsible for delivering the content or data (e.g., VOD server 105, application server 104, etc.). The requests are transmitted to the headend via e.g., the hub entity 206 associated with the CPE 106 on which the action occurred. These requests may be for example tuning requests, LSCP stream control commands, etc.

The user actions may also be compiled by the client application running on the CPE 106, and sent periodically or as required upstream (e.g., via OOB channel or the like) per step 804. For instance, a log may be maintained by the CPE of user actions; the log file can then be sent to the database and server 202 or other entity for analysis.

In one variant, one or more BSA servers 196 are associated with each hub entity 206. The BSA servers 196 can be adapted to compile information regarding user actions at the various CPEs 106 associated with the hub 206 on which the server 196 is located. For example, the BSA servers 196 collect data regarding tuning events from each of the CPE 106; e.g., each instance of a CPE 106 tuning to or away from charitable content-delivering channels can be recorded by the BSA server or switch, as well as other user actions of relevance.

Per step 806, the relevant server or other collecting entity (e.g., charity server and database 202, VOD server 105, BSA server 196, etc.) collects the relevant user data. As information is collected by the collecting entity, it is associated, at step 808, with the particular CPE 106 or account on which the event occurred.

In one embodiment, the collecting entity is adapted to analyze the collected data (step 810). Analysis may include, for example, compilation of various statistics regarding donation patterns of an individual or groups of individuals, assembly of lists of previous donors to particular charitable organizations or types of charitable organizations. At step 812, the data and/or analysis results may be stored either locally (e.g., at the database 202) or remotely.

Per step 816, the data may be utilized internally by the MSO. Potential uses for the event data will be discussed in detail below.

Alternatively, per step 818, the data is encrypted (as will be discussed below) to ensure subscriber privacy and anonymity and utilized by a third party (step 820).

In another aspect of the invention, the foregoing data which is collected (such as via the methodology of FIG. 8) may advantageously be utilized for the selection and/or delivery of targeted or contextually related charitable content based on e.g.,: (i) a user's historical patterns with respect to primary content and/or charitable content, and/or (ii) the programming or “primary” content which the user has requested or is watching. Each of these aspects is now described in greater detail.

In one embodiment, the invention utilizes contextually-related data associated with primary content selected or viewed by a user to select charitable content elements (e.g., advertising, promotions, videos, etc.) for temporally or spatially proximate delivery. See, e.g., co-owned and co-pending U.S. provisional patent application Ser. No. 60/995,655 entitled “METHODS AND APPARATUS FOR USER-BASED TARGETED CONTENT DELIVERY” filed Sep. 26, 2007, incorporated herein by reference, for exemplar methods and apparatus for contextual association of primary and secondary content within a content-based network. For instance, metadata within the primary content (e.g., first-run movie or the like) may indicate certain types or classes of content occurring at various places within the content. A TV show about a hospital for example (e.g., ABC's House program) which routinely includes content about diseases and various other maladies might for example be broadcast with metadata indicative of the content of certain scenes, such as the following:

Program—“House”

Genre—Medical

Scene Time or SI Index—00:01:03-00:01:05

Scene Topic—Breast Cancer

Subjective Emotional Content Rating—High

When the charity application (described subsequently herein) running on the relevant processing entity—which may include the BSA server, the VOD server, or even the CPE 106 as applicable—extracts and decodes this metadata, it knows that a “charity insertion opportunity” exists at the designated time/SI reference, and it also knows the type and metrics associated with this opportunity (i.e., that it relates to breast cancer, and that is emotionally “charged”, which may be exploited by the algorithm for effect in that viewers will tend to donate more when their emotions are high). Hence, the charity algorithm would seek charity-related content that matches one or more attributes in the decoded metadata, such as e.g., advertisements, hyperlinks or FVOD content relating to the American Cancer Society or the “Race for the Cure”.

These recommendations can be generated in advance of real time (e.g., by running the decoding and evaluation algorithm ahead of the actual current SI index, so that the best options for each insertion point are generated in advance), thereby preventing any latency. As the scene of interest plays within the primary content, an icon or emblem such as that described above can then be displayed, and the user taken to the relevant secondary (i.e., charity-related) content if they so desire such as by activating the icon or a remote control button. Alternatively, the icon or emblem can stay displayed continuously, and the linking (i.e., the secondary content that will be displayed if selected) changed so that secondary content that is contextually relevant to the current portion of the primary content is always enabled.

It will also be recognized that the aforementioned emblematic/iconic approaches may also be contextually related to broadcast, VOD, or other “primary” content. For example, the display of a link or icon to a given charity can be associated with the metadata of the primary content, so that a certain icon only appears or is only enabled when it is contextually relevant to the primary content.

Another method for the delivery of contextually-related charitable content in association with the primary content selected by the user is described in co-owned, co-pending U.S. patent application Ser. No. 11/198,620, filed Aug. 4, 2005 and entitled “Method and Apparatus for Context-Specific Content Delivery”, which is incorporated herein by reference in its entirety. Metadata associated with the primary content is provided by, e.g., the content originator or network operator, and is sent to a third party network entity (e.g., charitable content database) which returns contextually specific advertising matching the search terms. In one variant, the search term is simply one or more keywords drawn from the metadata and used as an input to a search engine. In another variant, more sophisticated analysis of the metadata is performed so as to ostensibly reduce the number of irrelevant or marginally relevant “hits” returned by the search engine.

In another embodiment, the invention of above referenced U.S. patent application Ser. No. 11/198,620 further provides a seamless visual integration/transition from the primary content to the secondary content (e.g., charitable content). In one embodiment, instead of placing the returned secondary content in an ancillary position around the primary content (e.g., video player window), the secondary content is placed within the display context of the primary content itself. The two different contents further are configured to appear as a single, integrated and seamless visual experience. This approach increases user satisfaction in a number of ways, and increases the effectiveness of the parent network site and primary/secondary content, thereby ostensibly increasing charitable donations.

### Subscriber Anonymity

It will be recognized that various aspects of the present invention are optimally implemented by having user- or CPE-specific data. To the degree that the provision of charitable content or data utilizes user-specific or CPE-specific data in its operation (such as in the data collection embodiments discussed above), such data can optionally be protected or processed so as to maintain subscriber privacy. For example, the MSO might use a mechanism to anonymously identify and associate the aforementioned data with particular CPE (and hence individual subscriber accounts). In one embodiment, subscriber identities are optionally protected by one-way cryptographic hashing or encryption of the tuner address or the like prior to logging and storage. The stored “hashed” address or other parameter (e.g., MAC, TUNER ID) and associated events are therefore not traceable to a particular user account, but the hash is advantageously unique and repeatable, so the necessary tuning location and user activity tracking may be performed while still maintaining complete subscriber anonymity. Alternatively, all or portions of the user-specific (albeit anonymous) information may be stripped off before storage of the activity or configuration data within the historical database. See, e.g., co-owned and co-pending U.S. patent application Ser. No. 11/186,452 filed Jul. 20, 2005 and entitled “Method and Apparatus for Boundary-Based Network Operation”, which is incorporated herein by reference in its entirety, for exemplary implementation of such anonymity mechanisms. Accordingly, the MSO can evaluate individual CPE 106 according to an activity, preference, or configuration analysis gleaned from that particular CPE (i.e., on a per-CPE basis) if desired.

### MSO as Charity

In another aspect of the invention, the MSO or network operator can itself act as a charity of sorts. For instance, in one embodiment, the MSO comprises a nationwide cable or satellite operator, with subscribers or customers disposed in various geographic regions of the country. When a certain region of the subscriber base experiences a disaster (e.g., hurricane Katrina hits subscribers living in New Orleans and surrounding areas), other subscribers of the same MSO that are not affected may wish to donate to the people living in that region. Under prior art approaches, such donations would be sent to an external entity (e.g., American Red Cross), who would then decide how and where the funds were spent. However, under the present embodiment, the MSO acts as both the receiver of the donation and the distributor, without involving an external entity. This reduces bureaucratic overhead, opportunity for mismanagement of “siphoning” off of funds for other uses, etc., since no external entity (e.g., charityper se) is involved. So, for instance Time Warner Cable subscribers in San Diego could designate funds to be sent to other Time Warner subscribers in New Orleans (if MSO coverage exists there), and the donors would know with a high degree of certainty that there donations were going directly into the affected area. The MSO (e.g., Time Warner), via its extensive subscriber database, would be able to rapidly identify its customers in the affected area, and may also even have demographic or other information useful for selecting the most “needy” of its subscribers (e.g., those residing in the hardest-hit flood areas, those with lowest incomes, those that are elderly or infirmed, etc.). The donor would not know exactly who in the affected area received their donation, but would know that some other Time Warner subscriber who had a bona fide need did receive it. The funds could be transferred using e.g., the “needy” subscriber's electronic payment account (i.e., a reverse electronic payment or credit to the subscriber's bank account), via mailed check, or other approach depending on the severity of the disaster.

This approach also has the possibility of an advantageous interpersonal “family dynamic”; i.e., Time Warner subscribers helping other Time Warner subscribers.

Similarly, the MSO in the foregoing example might partner with a charity or local entity (e.g., American Red Cross or local supermarket chain) in the affected area to funnel donations from the MSO's subscribers to a designated charity at the scene (contrast, at a national level), thereby helping assure that the funds are applied directly to those who need it, and in a prompt manner.

In another aspect, the MSO might also couple participation or donations to activities by one or more persons or organizations of interest; e.g., famous celebrities such as actors, sports figures, politicians, etc. For instance, if a famous actor were to participate in the Habitat for Humanity efforts to rebuild homes damaged by hurricane Katrina, then this might be an incentive for a fan of that actor to donate and/or participate as well. Hence, the MSO might enable or facilitate this donation/participation by providing its subscribers direct (e.g., on-demand) access to a short video or other information starring the famous actor; e.g., giving an impassioned plea fro assistance.

### Business Methods and Models

Various exemplary business-related aspects of present invention are now described in detail.

In one embodiment, payment is required from the charity to the MSO for incorporation of that organization's charitable content for provision to the MSO's subscribers. The amount of compensation required for the inclusion of a charitable organization's content may vary as a function of the number of times the content is cycled (e.g., in a series of charitable content trailers), may vary based on whether it is provided to all subscribers or merely to those having a past or current interest in the goals of the organization and/or in donating to the organization (as determined by the MSO based on charitable data collection methods discussed above), or yet other criteria.

As previously noted, there is significant advantage in delivering charitable content over an MSO/subscriber network, since the MSO may have appreciable useful information on the general or even personal demographics or -activities of its subscribers. Moreover, by incorporating the “instant” donation capability within the network as described elsewhere herein, there is yet further advantage to the charity (i.e., not only is their content being distributed to those most likely to have use for it, but such individuals may also immediately donate via a user-friendly and accessible medium (i.e., their DSTB and monitor), thereby mitigating donation “losses” that would otherwise occur if the donor were required to affirmatively call up the charity, send them a check in the mail, log onto a website, etc.

In yet another embodiment, the charitable organization may pay for having its content presented to users on a per-viewer basis. In other words, the organization would compensate the MSO based on the number of users that actually request delivery of the charitable content on demand. Alternatively, compensation for inclusion of an organization's content may be determined based on the amount of donations received by the entity via the on demand system; e.g., a scaled system wherein a higher level of donations commands a higher fee and/or rate (e.g., 1% of donations received paid to MSO for donations less than $1,000,000, 2% for greater amounts, etc.).

In another embodiment, the MSO would request an additional fee for placing portals to the charitable organization's content at premiere locations, including, inter alia, at the top of a list of charities, adjacent to frequently requested VOD content, near the beginning in a cycle of charitable content, on a list of related links, etc.

To promote donations as well as the purchase of purchasable content, incentives may be offered to users who donate and/or purchase purchasable content. For example, donations may be offered with the purchase of VOD content (the latter which may be completely unrelated to the charity); alternatively donating may be provided incentives by offering discounted or free purchasable content. In one variant, a user may be provided with an option to register his CPE or client device with one or more charities, thus ensuring that the user's VOD (and other) purchases trigger MSO contributions as well. Other incentives might include MSO-sponsored “points” or credits (somewhat akin to well known frequent-flyer miles) which when accrued to a given level, entitles a charitable donator to receive a particular benefit or service.

It is also appreciated that a charitable organization may be charged a premium for inclusion of the organization's charitable content into mechanisms for linking it to purchasable and non-purchasable content (e.g., presenting the charitable content prior to the commencement of related purchased content such as is commonly done at present for many web-based videos, or in the advertisement breaks of related broadcast or recorded content.)

In yet another embodiment, the MSO may entice users to donate by participating in the donation by, for example, matching a user's charitable donation to the same charity, or providing a comparable donation to another charity of the user's choice.

In another salient aspect of the invention, the MSO may act as a clearinghouse or guarantor for charitable organizations, and would provide assurances that the donations are made to reputable charitable organizations with legitimate goals. The MSO may offer reimbursements of a user's monetary donation if fraud is discovered among charitable organizations promoted by the MSO via its network. As is well known, many individuals will be hesitant to donate to charities that they might otherwise donate to if they cannot be assured of the veracity of the charity or the uses for their money. Many false or sham charities are set up every year (often immediately on the heels of a natural disaster or other such situation) so as to try to dupe contributors out of their funds. Hence, by presenting its subscribers with a reputable and unified interface for these vetted charities, and guaranteeing that the donations will make it to that charity, the MSO can ostensibly achieve a higher rate of donation than would otherwise be experienced for the general population. In one variant, the MSO prescribes certain acceptance criteria for the charity to be included on their listing, such as e.g., (i) existence of a prior audit or certification by the MSO, a designated financial institution, state or federal entity, etc.: (ii) charitable revenue over a certain threshold; (iii) history of X years or longer, etc.

The MSO may also provide a mechanism whereby a user may make a pre-set limit to the amount of contributions permitted over a defined period of time (such as no more than $1000 in charitable contributions per month, etc.). Likewise, the MSO may provide the user the ability to opt-out of receiving charitable content at a premium (e.g., for $X additional per month, no charitable content delivery or solicitations), and/or provide additional security measures (or guarantees) for purchases and/or donations.

Relationships between an MSO and various banking or financial entities (including credit card companies) may be formed in conjunction with the present invention. In other words, specific banking entities may offer the MSO consideration for enablement of the aforementioned ability to have charitable donations paid using their services. For example, Wells Fargo™ bank or Visa® may pay or otherwise compensate the MSO to give the bank's or credit card company's customers the ability to have money directly distributed from their bank account to a charitable organization via the systems described above. Similarly, the MSO may pay the bank or credit card company to provide such a service to the MSO's customers, and/or to match subscriber contributions by the MSO.

It is further noted that various entities may utilize data collected by the various collecting entities discussed above to further their business goals. For example, data collected regarding recent donors to a particular charitable organization and/or to a type of organization may be utilized to offer charitable organizations an opportunity to have charitable content delivery only to these subscribers (while maintaining subscriber anonymity). Under such a model, the MSO would, in exchange for consideration, apprise Charity X that 500 of its subscribers (who may remain anonymous) have in the past donated to Charity X, and that Charity X can use the MSO to deliver/targeted content to these 500 subscribers (e.g., additional solicitations, content, advertising, etc.) with great precision via the indigenous cable or satellite content delivery network (since the MSO knows, such as by way of one-way cryptographic hash or other unique yet anonymous identification mechanism, who these 500 subscriber are).

Moreover, the raw data itself may be useful to the charity, when coupled for example with demographic data. In one variant, the MSO collects charitable activity-related data (e.g., past donations, requests for charitable content, etc.), and correlates this with demographic data for the same users (which may none-the-less remain anonymous, but can be uniquely correlated to a particular hashed TUNER ID, MAC, etc.). Hence, the MSO can provide the charity with information, for a price or other consideration, such as that indicating the demographic breakdown of charitable contributors within its subscriber pool; e.g., 57% are male, 65% are between the ages of 50 and 75, 44% live in “affluent” zip codes, etc.).

In another exemplary business model, the “charitable” content may not be charitable at all, but rather used to provide incentive for the donation. For instance, the MSO might advertise an offer where an advance preview or showing of a new release music video, movie or television program is accessible to subscribers if they donate to one or more designated charities; e.g., to a designated one-time donation level, or on a recurring basis. Users might be able to access and watch all or a portion of “Batman—Dark Knight” via their VOD or PPV system for example before it is released in theaters, based on an agreement between the MSO, releasing film studio, and charity. This represents significant goodwill for the film studio and MSO (i.e., helping to cure breast cancer or the like), to the benefit of the charity. The methods and apparatus of co-owned and co-pending U.S. patent application Ser. No. 11/080,693 entitled “METHOD AND APPARATUS FOR NETWORK CONTENT DOWNLOAD AND RECORDING” filed Mar. 14, 2005 and incorporated herein by reference in its entirety may also be used in one embodiment to help assure content protection and limit the risk of possible surreptitious distribution or diminution of revenue based on such advance previews.

Other types of incentives may be used as the basis for a business model as well. For instance, the MSO might arrange to have the aforementioned famous actor be “live” on a blog, VoIP telephony channel, webcam video, etc. which is made accessible only to donators to a particular charity (and/or of a certain level of donation). Other incentives might include MSO-sponsored “points” or credits (somewhat akin to well known frequent-flyer miles) which when accrued to a given level, entitles the donator to receive a particular benefit or service.

In yet another business model of the invention, users (e.g., cable or satellite subscribers) are given the opportunity to enter into a “donation agreement” which commits them to at least a prescribed level of donation per period of time; e.g., at least $1,000 donated per year to any of the “listed” charities sponsored by the MSO. Various incentives can be offered in exchange for the commitment, such as for example: (i) access to content not generally available to non-donating subscribers; (ii) forbearance of external or internal solicitation attempts to the user by the listed charities (e.g., placement on a subscriber “do not call” list which screens them from solicitation calls, content delivery/advertisements, etc.); (iii) access to one or more famous personalities via one of the aforementioned media (i.e., blog, webeam, chat room, etc.); (iv) special or periodic updates on the activities of the charity, such as for example the step-by-step process, or progress of home rebuilding by Habitat for Humanity in areas affected by hurricane Katrina; or (v) tailoring of the charitable content delivered, such as delivery of only targeted charitable information as designated by the user or their profile (e.g., “show me only charitable information relating to cancer”).

The listed or sponsored charities may be changed as a function of time if desired by the MSO, and each individual charity can be differentiated with respect to others in terms of level of donation, duration of contract, etc.

It is noted that data regarding monetary donations made via the system (i.e., those made through the MSO rather than a user's bank account or credit card) may be presented to the user in the form of a detailed record for tax purposes; see also the discussion of the optional “tax engine” presented subsequently herein.

In another embodiment, similar to the methods previously discussed for providing a user with a schedule for volunteer opportunities, a schedule may be presented for the user to arrange for tangible items to be picked up at the user's house (e.g., donations of food, clothing, furniture, automobiles, etc.).

In yet another embodiment, the aforementioned systems and methods may be utilized to provide a user with a virtual shopping experience. In other words, the user would be provided with a virtual store, from which the user would be able to select items for donation (e.g., clothes, shoes, blankets, home items, etc.). The total cost of the items selected is tallied when the user finishes “shopping”, and a monetary donation in the amount of the items will be requested of the user (such as via the payment methods described elsewhere herein). As noted above with regard to the trustworthiness of the charitable organizations themselves, according to this embodiment, the MSO may also ensure to the users that the items purchased will in fact be delivered to the organization or persons the organization serves.

### Operations/Business Rules Engine

In another aspect of the invention, the charitable server and database 202 (or other network entity) may include one or more computer programs comprising so-called “rules” engines. These rules may be fully integrated within various entities associated with the present invention, or may be controlled via e.g., the users CPE 106. In effect, the rules engine comprises a supervisory entity that monitors and selectively controls the charitable content presentation and support functions at a higher level, so as to implement desired operational or business rules. The rules engine can be considered an overlay of sorts to the remote content management and delivery algorithms. For example, certain operational protocols or decision processes may be invoked based on requests received from the CPE 106 or server 105, 202, subscriber data, geographic data, etc. However, these processes may not always be compatible with higher-level business or operational goals, such as maximizing profit or system reliability. Hence, when imposed, the business/operational rules can be used to dynamically (or manually) control the distribution of charitable content and related features such as receiving donations, etc. The rules may be, e.g., operational or business-oriented in nature, or related to preservation of security, and may also be applied selectively in terms of time of day, duration, specific local areas, or even at the individual user level.

For example, one rule implemented by the rules engine may comprise providing donation matching to certain classes of subscribers (e.g., those at a premium level of service, or subscribers who have “opted-in” to receiving the charitable content). Hence, whenever a subscriber meeting certain requirements makes a donation, a prescribed match is paid out by the MSO to the same charity (or charities). This approach tends to provide incentive for subscriber donations, in that the effect of a given donation is magnified.

Another rule might comprise the selective allocation (or deallocation) of bandwidth or network resources such as VOD servers or QAMs to charitable content delivery. For instance, where bandwidth is constrained, a moratorium on instantiating new VOD sessions for delivery of charitable content may be imposed, so that higher revenue-producing uses for the bandwidth can be pursued. Conversely, charitable content could be the last type of content to be sacrificed under such conditions, such as during disasters or emergencies (e.g., Hurricane Katrina or post Sep. 11, 2001) where it is anticipated that a large volume of donations would be made.

Yet another rule might relate to the broadcast delivery of content via a BSA network such as that of FIG. 1C herein. For example, charitable content might be treated differently in terms of switching decisions; e.g., it might be designated as “popular” content and hence protected from being switched out. See, e.g., co-owned and co-pending U.S. patent application Ser. No. 10/429,998 entitled “TECHNIQUE FOR EFFECTIVELY PROVIDING PROGRAM MATERIAL IN A CABLE TELEVISION SYSTEM” filed May 5, 2003, incorporated herein by reference in its entirety, for exemplary methods and apparatus for preventing certain types of broadcast content from being switched off.

In another aspect of the invention, an optional “tax engine” is included within the subscriber's CPE 106, such as via an application integrated with the client software running on the CPE. The tax engine includes a user interface which allows the user to enter data regarding their local, state or federal taxes, income, expenses, etc., so that the effect of one or more donations can be determined in advance. As is well known, one significant incentive to many people for donating is the availability of a deduction on their income taxes. However, for all but the very astute, the real world or net effect of this deduction may not be readily known, since in many cases there are numerous considerations and technicalities which determine whether a donation is deductible and to what degree it will reduce the user's tax burden. Hence, the present invention uses a software application which stores relevant data for one or more users (e.g., different members of a family) that allows the user(s) to perform a “sensitivity” analysis on various donation amounts or schemes. For instance, one embodiment of the invention employs data from a user's prior year tax return(s) as a basis for calculation; the user simply enters a proposed donation amount and charity, or selects these items from a list or menu, and the software automatically determines eligibility of the proposed selection for a federal and/or state deduction, and also calculates the net tax savings for the user. This information can be stored for later review as well. The sensitive user data can be stored on the CPE (e.g., storage device), or any other storage media in communication therewith. It may also be encrypted or password protected for additional security.

Moreover, such “tax engine” can be disposed on a network device if desired, such as the aforementioned charitable server and database 202, or even within the MSO billing module 152. The relevant status and calculations can then be sent back and displayed to a user once they indicate a prospective intent to donate, such as via a confirmation display screen or GUI of the type well known in the computer arts. If the user does not like the results, they can cancel the donation (not confirm), and insert another amount, pick another charity, etc.

Many other approaches and combinations are envisaged consistent with the invention, as will be recognized by those of ordinary skill when provided this disclosure.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. This description is in no way meant to be limiting, but rather should be taken as illustrative of the general principles of the invention. The scope of the invention should be determined with reference to the claims.

What is claimed is:

1. For use in a content based network, an apparatus adapted for charitable content delivery, said apparatus comprising:
a processor;
a network interface
a storage device in data communication with said processor; and
a software process operative to run on said processor, wherein said software process is adapted to:
generate information regarding available charitable content elements;
receive a user selection of one or more of said available charitable content elements;
deliver said selected one or more charitable content elements to said user; and
receive a donation from said user.

2. The apparatus of claim 1, wherein said apparatus comprises a cable television network headend or switching hub server.

3. The apparatus of claim 2, wherein said apparatus comprises a VOD server.

4. The apparatus of claim 1, wherein said delivery comprises storing a plurality of available charitable content elements on said storage device.

5. The apparatus of claim 1, wherein said delivery comprises sending said selected charitable content to a designated network address or location.

6. The apparatus of claim 1, wherein said delivery comprises displaying said selected charitable content on a display device in data communication with said apparatus.

7. The apparatus of claim 1, wherein said receipt of a donation comprises receiving information relating a donation and said user.

8. In a content-based network having a plurality of subscribers associated therewith, a method of providing charitable content to at least one subscriber, said method comprising:
providing a plurality of charitable content to said at least one subscriber;
receiving at least one selection from among said plurality of charitable content from said at least one subscriber; and
providing said at least one selected charitable content to said subscriber over said network;
receiving at least one command from said at least one subscriber authorizing a monetary donation to a charitable organization associated with said charitable content; and
billing said at least one subscriber an amount based at least in part on said delivered monetary donation.

9. The method of claim 8, wherein said act of providing a plurality of charitable content comprises providing said user a list of said available charitable content.

10. The method of claim 8, wherein said act of receiving at least one selection from among said plurality of charitable content comprises:
said at least one subscriber selecting one or more of said plurality of charitable content using a remote control device; and
transmitting said selections to a network server using a session control protocol.

11. The method of claim 8, wherein said act of providing a plurality of charitable content comprises:
accessing metadata associated with at least one of said plurality of charitable content;
evaluating said metadata with respect to a profile associated with said at least one subscriber; and
selecting one or more of said plurality of charitable content based at least in part on said act of evaluating.

12. The method of claim 11, wherein said profile comprises metadata associated with at least one of (i) viewing patterns, (ii) charitable content requests, or (iii) charitable donations of said at least one subscriber.

13. For use in a content-based network having a plurality of users associated therewith, a method of providing exchange of information between a network user and a charitable organization, said method comprising:
providing said user with access to a plurality of charitable organizations;
selecting an option to communicate with at least one of said organizations;
generating a message based on said selection; and
delivering said message to said selected at least one charitable organization.

14. The method of claim 13, wherein said act of selecting an option to communicate with said charitable organization comprises said user selecting an option to receive additional information from said organization via their network CPE.

15. The method of claim 14, wherein said message comprises contact information regarding said user comprising at least one of a name, physical address, email address, or telephone number of said user.

16. The method of claim 15, wherein said act of generating said message comprises said user entering said information.

17. The method of claim 15, wherein said act of generating said message occurs automatically by utilization of stored contact information regarding said user.

18 The method of claim 17, wherein said stored information comprises information contained in a billing or subscriber database maintained by an operator of said network.

19. The method of claim 13, wherein said act of selecting an option to communicate with said charitable organization comprises said user selecting an option to make a charitable donation to at least one of said organizations.

20. The method of claim 19, wherein said message comprises information necessary to bill a user an amount at least equal to said user's donation.

21. The method of claim 13, wherein said act of selecting an option to communicate with said charitable organization comprises confirming a scheduled appointment.

22. The method of claim 13, wherein said providing said user with access to a plurality of charitable organizations comprises creating a virtual channel for viewing by said user, said virtual channel integrating charitable content from at least two different sources.

23. The method of claim 22, wherein said integrating content from at least two different sources comprises presenting content that is delivered via two different delivery modes.

24. The method of claim 13, wherein said message comprises scheduling information comprising at least date, time, and location.

25. The method of claim 13, wherein said message comprises information relating to at least one of: (i) user's desire to volunteer time, and (ii) to a donation pick-up time.

26. Computer readable apparatus comprising media adapted to contain a computer program having a plurality of instructions, said plurality of instructions which, when executed:
generate a list of available charitable content for display;
display said list of available charitable content to a user;
enable selection of one or more of said available charitable content; and
cause delivery of said selected one or more charitable content to at least said user.

27. The computer-readable apparatus of claim 26, wherein said apparatus is disposed on a client premises device in communication with a cable network, and said act of generating a list of available charitable content comprises obtaining metadata from a network server.

28. The computer program of claim 26, wherein said program is her adapted to enable selection of one or more subsequent actions with respect to said selected charitable content.

29. The computer program of claim 28, said subsequent actions comprise at least one of:
donating to said one or more charitable organization;
receiving additional information regarding said one or more charitable organizations; or
scheduling events with said one or more charitable organizations.

30. The computer program of claim 26, wherein said program is further adapted to:
collect data regarding user preferences, said data comprising data regarding a user's prior charitable content selections, prior charitable donations, or general viewing patterns;
evaluate metadata regarding said available charitable content;
generate a list of available charitable content matching said user preferences.

31. A system for providing opportunities for viewing charitable content and making charitable donations in a content based network, said system comprising:
a processing apparatus, said processing apparatus being adapted to generate a list of available charitable content;
a first user interface enabling a viewer to select one or more of said available charitable content;
apparatus adapted to allocate a carrier to deliver said selected one or more charitable content;
a receiving apparatus, said receiving apparatus adapted to receive said charitable content; and
a second user interface enabling a viewer to designate a donation to said charitable organization.

32. The system of claim 31, wherein said donation to said charitable organization comprises a monetary donation and wherein said system further comprises apparatus adapted to:
deliver said monetary donation to a charitable organization associated with said charitable content; and
bill said viewer a monetary amount for donation.

33. The system of claim 31, wherein said donation to said charitable organization comprises a donation of non-monetary assets, and wherein said system further comprises apparatus adapted to send a message comprising information regarding said donation and said viewer to said charitable organization.

34. The system of claim 31, wherein said processing apparatus comprises a cable television network headend or switching hub server.

35. The system of claim 31, wherein said processing apparatus is located substantially on a consumer premises device, and said receiving apparatus comprises a hard disk drive of said consumer premises device.

36. The system of claim 31, wherein said apparatus adapted to allocate a carrier to deliver said selected one or more charitable content comprises a VOD server in data communication with one or more remote charitable content stores and adapted to access charitable content stored thereon.

37. The system of claim 31, further comprising a data collection apparatus adapted to collect data regarding individual ones of said plurality of CPE, said data comprising information relating to: (i) said charitable organizations about which charitable content is requested from individual ones of said plurality of CPE, or (ii) an amount of charitable donations made from individual ones of said plurality of CPE.
